(19) United States
(12) Patent Application Publication
(10) Pub. No.: US 2015/0197682 A1
(43) Pub. Date: Jul. 16, 2015

(54) ANTI-GEL AGENT FOR POLYHYDROXYETHERAMINES, GEL STABILIZED POLYHYDROXYETHERAMINE SOLUTIONS, AND METHODS FOR MAKING AND USING SAME

(71) Applicant: CLEARWATER INTERNATIONAL, LLC, Houston, TX (US)

(72) Inventor: Duane S. Treybig, Houston, TX (US)

(21) Appl. No.: 14/595,276

(22) Filed: Jan. 13, 2015

Related U.S. Application Data
(60) Provisional application No. 61/928,228, filed on Jan. 16, 2014.

(51) Int. Cl. C09K 8/32; C09K 8/12

(52) U.S. Cl. CPC C09K 8/32; C09K 8/12

(57) ABSTRACT

Anti-gel agents for polyhydroxyetheramines/copolyhydroxyetheramines and gel stabilized polyhydroxyetheramine/copolyhydroxyetheramine solutions including a polymer system including polyhydroxyetheramines and/or copolyhydroxyetheramines and an anti-gel system including quaternary ammonium compounds, quaternary phosphonium compounds, or mixtures and combinations.

### RELATED APPLICATIONS

The present invention claim provisional priority to and the benefit of U.S. Provisional Patent Application Ser. No. 61/928,228 filed 16 Jan. 2014 (01/16/2014)(16.01.2014).

### BACKGROUND OF THE INVENTION

1. Field of the Invention

Embodiments of the present invention relate to anti-gel agents for polyhydroxyetheramines, gel stabilized polyhydroxyetheramine solutions, and methods for making and using same.

More particularly, embodiments of the present invention relate to anti-gel agents for polyhydroxyetheramines and gel stabilized polyhydroxyetheramine solutions, where the polyhydroxyetheramines comprise polymers of diglycidyl ethers of a dihydric phenol and amines having two amine hydrogens and the anti-gel agents comprise quaternary ammonium compounds, quaternary phosphonium compounds, or mixtures and combinations thereof and methods for making and using same.

2. Description of the Related Art

Hydroxyphenoxyether polymers are known to be useful in the fabrication of articles exhibiting barrier properties. See, for example, Reinking et al., J. Poly. Sci., Vol. 7, pp. 2135-2144, pp. 2145-2152 and pp. 2153-2160 (1963) and Encyclopedia of Polymer Science and Technology, Vol. 10, pp. 111-122. Such polymers generally have only moderate oxygen barrier, i.e., they generally exhibit oxygen transmission rates of 2 cm³-mil/100 in²-atm(O₂)-day to 75 cm³-mil/100 in²-atm(O₂)-day.

In view of the limited barrier properties of the prior art polymers having pendant hydroxyl moieties and phenoxyether moieties, it would be highly desirable to provide a polymer having a high barrier (i.e., oxygen transmission rate less than 5 cm³-mil/100 in²-atm(O₂)-day) to oxygen. Polymers that retain such high barrier in both dry and moist environments would be especially desirable.

U.S. Pat. No. 5,275,853 disclosed polyetheramines having improved barrier to oxygen are thermoplastic polymers having aromatic ether/amine repeating units in their backbones and pendant hydroxyl moieties. Such polyetheramines are prepared by reacting diglycidyl ethers of dihydric aromatic compounds such as the diglycidyl ether of bisphenol-A, hydroquinone, or resorcinol with amines having no more than two amine hydrogens per molecule, such as piperazine or ethanolamine

U.S. Pat. No. 5,464,924 disclosed polyetheramines prepared by reacting (1) a primary amine or bis(secondary) diamine with (2) a diglycidyl ether and (3) an amine- or epoxy-functionalized poly(alkylene oxide) exhibit a combination of low glass transition temperature (Tg of 14° C. to 73° C.) and low oxygen transmission rate (OTR of 0.53 cc-mil/100-in²-atm-day to 19.0 cc-mil/100-in²-atm-day).

U.S. Pat. No. 7,417,011 disclosed methods of modifying the permeability to water of a subterranean formation comprising injecting into the subterranean formation an aqueous composition comprising from about 0.005 percent to about 2 percent, by weight, of a water-soluble alkylene oxide branched polyhydroxyetheramine or a salt thereof, wherein the alkylene oxide branched polyhydroxyetheramine is prepared by reacting a diepoxide with one or more alkylene oxide functionalized amines and one or more amines having two reactive hydrogen atoms and optionally reacting the resulting polyhydroxyetheramine with an acid or alkylating agent to form the salt.

U.S. Pat. No. 7,893,136 disclosed water soluble polymers comprising a copolyhydroxyetheramine having side-chains of polyalkylene oxides, an aqueous solution of said polymer and process for preparing the copolyhydroxyetheramine.

These polymers have limited application in downhole applications because they tend to gel at temperatures above about 60° C. (140° F.). Thus, there is a need in the art for compositions of these polymers that have improved anti-gel properties at temperature up to about 200° C. (392° F.).

### SUMMARY OF THE INVENTION

Embodiments of the present invention provide compositions comprising:

a polyhydroxyetheramine, a copolyhydroxyetheramines or a mixture of polyhydroxyetheramine and/or copolyhydroxyetheramines polymers represented by the formula:

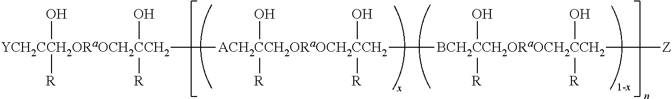

where:

R is independently selected from hydrogen and C₁-C₂₀ alkyl;

R^{a} is individually selected from an aromatic moiety and a substituted aromatic moiety;

Y is a hydrogen atom or an organic moiety that does not contain an epoxy group;

Z is a hydrogen atom or an organic moiety optionally containing an epoxy group;

n is 5-400;

x a real number having a value between 0.0 and 1.0;

A is individually selected from an amino group represented by one of the following formulas:

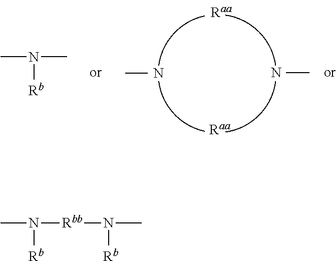

where:
R^{b} is independently selected from hydrocarbyl group and substituted hydrocarbyl group;
R^{aa} is independently selected from C₂-C₁₀ hydrocarbylene group or substituted hydrocarbylene group;
R^{bb} is independently selected from C₂-C₂₀ hydrocarbylene and substituted hydrocarbylene; and the substituent(s) is independently selected from the group consisting of hydroxyl, cyano, halo, aryloxy, alkylamido, arylamido, alkycarbonyl, or arylcarbonyl; and

B is represented by the formula:

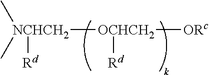

where:
R^{c} is hydrocarbyl group;
R^{d} is independently selected from the group consisting of hydrogen and hydrocarbyl group; and
k is an integer having a value between 1 and 1000, and

an effective amount of an anti-gelling system comprising quaternary ammonium compounds, quaternary phosphonium compounds, or mixtures and combinations thereof.

The effective amount of the anti-gelling system may be between about 0.03 wt. % and about 20 wt. %, optionally between about 0.05 wt. % and about 10 wt. %, optionally between about 0.1 wt. % and about 10 wt. %, optionally between about 0.1 wt. % and 5 wt. % based on the weight of hydroxyetheramine polymer system.

In certain embodiments, the molar ratio of propylene oxide to ethylene oxide in the polyalkylene oxide section of formula B is approximately 3/19 or approximately 10/32; and k is a real number yielding an approximate molecular weight between 1000 and 2000.

In certain embodiments, the compositions further comprise an aqueous base fluid such as water to form aqueous compositions. In other embodiments, the compositions further comprise an oil base fluid to form aqueous compositions.

In certain embodiments, a viscosity of the compositions remains under 230 cps in the temperature range between 100° F. (37.8° C.) and 400° F. (204.4° F.). In certain embodiments, R is hydrogen; R^{a} is independently selected from the group consisting of isopropylidenediphenylene, 1,4-phenylene, 1,3-phenylene, methylenediphenylene, thiodiphenylene, and carbonydiphenylene; R² is independently selected from the group consisting of methyl, ethyl, phenyl, benzyl, 2-hydroxyethyl, 3-hydroxypropyl, 2-hydroxypropyl, 2,3-dihydroxypropyl, 2-(acetamido)ethyl; and R^{aa} and R^{bb} are independently selected from the group consisting of ethylene, 1,2-propylene, 1,2-butylene, and R^{c} is a C₁₋₂₀ alkyl group. In other embodiments, R^{a} is isopropylidenediphenylene; R^{b} is 2-hydroxyethyl; R^{c} is hydrogen, methyl, ethyl, propyl, butyl, benzyl or combination thereof; R^{d} is a mixture of hydrogen and methyl; Y is N-(2-hydroxyethyl)piperazinyl or bis(2-hydroxyethyl)amino; Z is N-(2-hydroxyethyl)piperazinyl or bis(2-hydroxyethyl)amino, and n is 10-25.

Embodiments and aspects of the present invention provide methods of reducing the water permeability of a wellbore during the drilling comprising the step circulating a fluid in the wellbore, where the fluid includes a permeation modifying effective amount of a permeation modifier composition of this. In certain embodiments, the fluid comprises a drilling fluid. In other embodiments, the drilling fluid comprises a water base drilling fluid. In other embodiments, the drilling fluid comprises an oil-based drilling fluid.

In other embodiments, the fluid comprises part of a pill. In other embodiments, the pill comprises an aqueous carrier liquid.

In other embodiments, the aqueous carrier liquid is an aqueous salt solution. In other embodiments, the salt in the aqueous salt solution is selected from the group consisting of potassium chloride, sodium chloride, sodium bromide, sodium acetate, ammonium chloride, and calcium chloride and is present in the aqueous salt solution in an amount in the range between about 0.01% and about 10% by weight of solution. In other embodiments, the range is between about 0.02% and 5% by weight of solution. In other embodiments, the range is between about 0.02% and 2.5% by weight of solution. In other embodiments, the range is between about 0.02% and 2% by weight of solution. In other embodiments, the range is between about 0.02% and 1% by weight of solution.

In other embodiments, the fluid reduces a water permeability of limestone in the wellbore. In other embodiments, the fluid reduces a water permeability of sandstone in the wellbore. In other embodiments, the fluid reduces a water permeability of a proppant pack.

In certain embodiments, the quaternary ammonium compounds comprise tetrahydrocarbyl ammonium salts, and the quaternary phosphonium compounds comprise tetrahydrocarbyl phosphonium salts, or mixtures and combinations thereof.

In certain embodiments, the tetrahydrocarbyl ammonium salts are represented by the formula:

R¹R²R³R⁴N⁺Q⁻

where R¹, R², R³, and R⁴ are the same or different hydrocarbyl groups having between 1 and 80 carbon atoms, where at least one of the hydrocarbyl groups has at least 8 carbon atoms and where Q⁻ is a halide ion (e.g., F⁻, Cl⁻, Br⁻, and I⁻), a CH₃SO₄⁻ group, a CH₃CH₂SO₄⁻ group, a hydroxide ion (OH⁻), an acetate ion (OAc⁻), or mixtures and combinations thereof, and

the tetrahydrocarbyl phosphonium salts are represented by the formula:

R¹R²R³R⁴P⁺Q⁻

where R¹, R², R³, and R⁴ are the same or different hydrocarbyl groups having between 1 and 80 carbon atoms, where at least one of the hydrocarbyl groups has at least 8 carbon atoms and where Q⁻ is a halide ion (e.g., F⁻, Cl⁻, Br⁻, and I⁻), a CH₃SO₄⁻ group, a CH₃CH₂SO₄⁻ group, a hydroxide ion (OH⁻), an acetate ion (OAc⁻), or mixtures and combinations thereof.

### BRIEF DESCRIPTION OF THE DRAWINGS

The invention can be better understood with reference to the following detailed description together with the appended illustrative drawings in which like elements are numbered the same:

FIG. 1 depicts a viscosity versus temperature plot of P1.

FIG. 2 depicts a viscosity versus temperature plot of P1 including an anti-gel system of this invention.

FIG. 3 depicts regain brine permeability after treatment with 0.4% blend of P1 and G1 of Example 3 in 2% KCl.

### DEFINITIONS OF TERM USED IN THE INVENTION

The following definitions are provided in order to aid those skilled in the art in understanding the detailed description of the present invention.

The term “hydrocarbyl” means a univalent group formed by removing a hydrogen atom from a hydrocarbon.

The term “hydrocarbylene” means a divalent group formed by removing two hydrogen atoms from a hydrocarbon, the free valencies of which are not engaged in a double bond.

The term “carbyl” and “hydrocarbyl” are used interchangeably throughout the application.

The term “polyhydroxyaminoether” and “polyhydroxyetheramine” are used interchangeably throughout the application and mean the same thing.

The term “PHEA” means polyhydroxyetheramines.

The term “CPHEA” means copolyhydroxyetheramines.

The term “PHEA/CPHEA” means a composition including a polyhydroxyetheramine, a plurality of polyhydroxyetheramine, a copolyhydroxyetheramines, a plurality of copolyhydroxyetheramines, or mixtures thereof.

The term “anti-gelling” means a compound that inhibits, reduces, or interferes with PHEA/CPHEA containing compositions from gelling.

The term “about” means that the value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “substantially” means that the value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “drilling fluids” refers to any fluid that is used during well drilling operations including oil and/or gas wells, geo-thermal wells, water wells or other similar wells.

An over-balanced drilling fluid means a drilling fluid having a circulating hydrostatic density (pressure) that is greater than the formation density (pressure).

An under-balanced and/or managed pressure drilling fluid means a drilling fluid having a circulating hydrostatic density (pressure) lower or equal to a formation density (pressure). For example, if a known formation at 10,000 ft (True Vertical Depth—TVD) has a hydrostatic pressure of 5,000 psi or 9.6 lbm/gal, an under-balanced drilling fluid would have a hydrostatic pressure less than or equal to 9.6 lbm/gal. Most under-balanced and/or managed pressure drilling fluids include at least a density reduction additive. Other additives may be included such as corrosion inhibitors, pH modifiers and/or a shale inhibitors.

The term “gpt” means gallons per thousand gallons.

The term “ppt” means pounds per thousand gallons.

The term “ppg” means pounds per gallon.

The term “cc” means cubic centimeters.

### DETAILED DESCRIPTION OF THE INVENTION

The inventor has discovered that novel anti-gelling polyhydroxyetheramine (PHEA) or copolyhydroxyetheramine (CPHEA) compositions may be formulated, where the gelling behavior of the PHEA/CPHEA is interrupted, reduced, inhibited or interfered with by the inclusion an effective amount of an anti-gelling system, where the anti-gelling system includes quaternary ammonium compounds, quaternary phosphonium compounds, or mixtures and combinations thereof. The inventor has also found that when an effective amount of the anti-gelling system was added to a PHEA/CPHEA aqueous composition, the blue tint of the PHEA/CPHEA aqueous solution (believed to be an indication of a colloidal suspension or dispersion) disappears and the resulting PHEA/CPHEA aqueous composition does not gel at temperatures up to 400° F. (204.4° C.). Currently, PHEA/CPHEA compositions are limited in downhole applications as relative permeation modifiers to temperatures below about 140° F. (60° C.). The inclusion of an effective amount of the anti-gelling system of this invention permits PHEA/CPHEA compositions to have wide utility as relative permeation modifiers for downhole application in temperature exceeding 140° F. In certain embodiments, the useful temperature range of the gel stabilized PHEA/CPHEA compositions includes temperatures up to about 400° F. While PHEA/CPHEA containing compositions have utility in application below about 140° F. (60° C.), a problem with PHEA/CPHEA containing composition still exists and that is shipment and storage. In many places of the world, temperatures encountered during shipment and storage of PHEA/CPHEA containing compositions may exceed 140° F. (60° C.) resulting in the irreversible gelling of the PHEA/CPHEA material in transit or storage even further limiting PHEA/CPHEA applications for downhole uses. On the contrary, the compositions of the present invention including PHEA/CPHEA and an anti-gelling system greatly reduces the likelihood of PHEA/CPHEA gelling during shipment, storage and use. In fact, the inventor has found that PHEA/CPHEA compositions of this invention remain useable at temperature well in excess of 140° F. (60° C.) so that the compositions will remain substantially free or free of gel at temperatures up to 400° F. (204.4° C.) permitting shipment, storage and use in climates, where shipment and storage temperature exceed 140° F. (60° C.), the gellation temperature for PHEA/CPHEA containing compositions in the absence of the anti-gelling system of this invention.

For example, the PHEA/CPHEA material XU-19105.00 manufactured by Dow Chemical Company, designated P1, is a polyhydroxyetheramine (PHEA) or copolyhydroxyetheramine (CPHEA) prepared by reacting bisphenol A diglycidyl ether with a polyoxyalkylenemonoamine (see, e.g., U.S. Pat. Nos. 7,893,136; 5,464,924; and 5,275,853, incorporated by reference per the last paragraph of the specification) and exits as a suspension of microparticles in water. Such PHEA/CPHEA compositions have a slight blue tint, which is believed to be due to Raleigh scattering. Raleigh scattering is the elastic scattering of light or other electromagnetic radiation by particles much smaller than the wavelength of light. Therefore, the microparticles of such PHEA/CPHEA compositions are smaller than the visible wavelengths of light. Such PHEA/CPHEA compositions are known to gel at a temperature between about 46° C. and about 60° C. Therefore, such PHEA/CPHEA compositions are limited for use as a relative permeation modifier in wells with a temperature less than 55° C. Moreover, in the oil fields of Texas, South America, the Middle East, etc. where temperatures sometimes reach as high as 130° F., there is a strong likelihood that such PHEA/CPHEA compositions would gel in the drum or tote. Thus, an aspect of the present invention was to find materials that are capable of extending the usable temperature range of PHEA/CPHEA containing compositions such as P1 above their gellation temperatures or to act as temperature stabilizing agents or anti-gelling agents for PHEA/CPHEA containing compositions.

### Polyhydroxyetheramines (PHEAs) and Copolyhydroxyetheramines (CPHEAs)

In certain embodiments, the polyhydroxyetheramine (PHEA), the copolyhydroxyetheramine (CPHEA), and/or mixtures of PHEA polymers and/or CPHEA polymers represented by the formula:

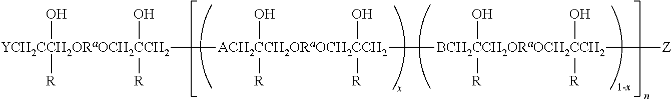

R is independently selected from hydrogen and C₁-C₂₀ alkyl;

R^{a} is individually selected from an aromatic moiety and a substituted aromatic moiety;

Y is a hydrogen atom or an organic moiety that does not contain an epoxy group;

Z is a hydrogen atom or an organic moiety optionally containing an epoxy group;

n is 5-400;

x a real number having a value between 0.0 and 1.0;

A is individually selected from an amino group represented by one of the following formulas:

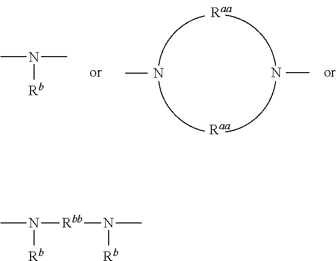

where:
R^{b} is independently selected from hydrocarbyl group and substituted hydrocarbyl group;
R^{aa} is independently selected from C₂-C₁₀ hydrocarbylene group or substituted hydrocarbylene group;
R^{bb} is independently selected from C₂-C₂₀ hydrocarbylene and substituted hydrocarbylene; and the substituent(s) is independently selected from the group consisting of hydroxyl, cyano, halo, aryloxy, alkylamido, arylamido, alkycarbonyl, or arylcarbonyl; and

B is represented by the formula:

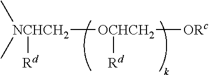

where:
R^{c} is hydrocarbyl group;
R^{d} is independently selected from the group consisting of hydrogen and hydrocarbyl group; and
k is an integer having a value between 1 and 1000.

### Quaternary Ammonium Compounds and Quaternary Phosphine Compounds

In certain embodiments, the quaternary ammonium compounds comprise tetrahydrocarbyl ammonium salts, tetrahydrocarbylphosphonium salts, or mixtures and combinations thereof.

In certain embodiments, the tetrahydrocarbyl ammonium salts are represented by the formula:

R¹R²R³R⁴N⁺Q⁻

where R¹, R², R³, and R⁴ are the same or different hydrocarbyl groups having between 1 and 80 carbon atoms, where at least one of the hydrocarbyl groups has at least 8 carbon atoms and where Q⁻ is a halide ion (e.g., F⁻, Cl⁻, Br⁻, and I⁻), a CH₃SO₄⁻ group, a CH₃CH₂SO₄⁻ group, a hydroxide ion (OH⁻), an acetate ion (OAc⁻), or mixtures and combinations thereof, and

the tetrahydrocarbyl phosphonium salts are represented by the formula:

R¹R²R³R⁴P⁺Q⁻

where R¹, R², R³, and R⁴ are the same or different hydrocarbyl groups having between 1 and 80 carbon atoms, where at least one of the hydrocarbyl groups has at least 8 carbon atoms and where Q⁻ is a halide ion (e.g., F⁻, Cl⁻, Br⁻, and I⁻), a CH₃SO₄⁻ group, a CH₃CH₂SO₄⁻ group, a hydroxide ion (OH⁻), an acetate ion (OAc⁻), or mixtures and combinations thereof.

### Quaternary Ammonium Compounds

In certain embodiments, the tetrahydrocarbyl ammonium salts comprise trihydrocarbylalkyl ammonium salts or mixtures of trihydrocarbylalkyl ammonium salts represented by the formula:

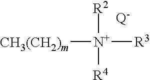

where m is an integer having a value between 6 and 40, R², R³, R⁴, and Q⁻ are as previously defined. In other embodiments, the trihydrocarbylalkylammonium salt comprises dodecyltrimethyl ammonium chloride, cocoalkyltrimethylammonium chloride, hexadecyltrimethyl ammonium chloride, tallowalkyltrimethyl ammonium chloride, C₁₂-C₁₆ alkyl dimethyl benzyl ammonium chloride, C₁₂-C₁₆ alkyl dimethyl ethyl ammonium ethoxysulfate, di(octadecyl-hexadecyl)dimethyl ammonium chloride, di(C₁₂-C₁₆ alkyldimethylamine) diethyl ether dichloride, tricapryl methyl ammonium chloride, and mixtures or combinations thereof. In other embodiments, the trihydrocarbylalkylammonium salt comprises dodecyltrimethyl ammonium chloride or C₁₂-C₁₆ alkyl dimethyl benzyl ammonium chloride. In other embodiments, the trihydrocarbylalkylammonium salt comprises cocoalkyltrimethylammonium chloride. In other embodiments, the trihydrocarbylalkylammonium salt comprises hexaldecyltrimethyl ammonium chloride. In other embodiments, the trimethylalkylammonium salt comprises tallowalkyltrimethyl ammonium chloride.

In certain embodiments, the tetrahydrocarbyl ammonium salts comprise dihydrocarbyl dialkyl ammonium salts or mixtures of dihydrocarbyl dialkyl ammonium salts represented by the formula:

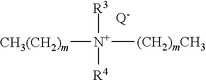

where each m is an integer having a value between 6 and 40, R³, R⁴, and Q⁻ are as previously defined. In other embodiments, the dihydrocarbyldialkylammonium salt comprises didodecyldimethyl ammonium chloride, dicocoalkyldimethylammonium chloride, dihexadecyldimethyl ammonium chloride, ditallowalkyldimethyl ammonium chloride, and mixtures or combinations thereof.

In certain embodiments, the tetrahydrocarbyl ammonium salts are amido trihydrocarbyl ammonium salts represented by the following formula:

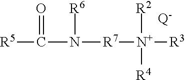

where R², R³, R⁴, and Q⁻ are as previously defined, R⁵ is a hydrocarbyl group having between 1 and 80 carbon atoms, R⁶ is a hydrogen atom or a hydrocarbyl group having between 1 and 80 carbon atoms, and R⁷ is a linking group having between 1 and 10 carbon atoms. Exemplary examples include, without, limitation, oleylamidopropyltrimethyl ammonium chloride, laurylamidopropyltrimethyl ammonium chloride, cocoamidopropyltrimethyl ammonium chloride, cocoamidopropyldimethyl benzyl ammonium chloride, cocoamidopropyldimethylethyl ammonium ethoxysulfate are examples of hydrocarbylamidopropyltrialkyl ammonium quaternaries.

In certain embodiments, the quaternary ammonium compounds comprise diammonium salts represented by the formula:

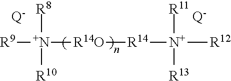

where R⁸, R⁹, R¹⁰, R¹¹, R¹², and R¹³ are independently hydrocarbyl group having between 1 and 80 carbon atoms, R¹⁴ are independently linking groups having between 1 and 4 carbon atoms, and Q is as previously defined, and n is an integer having a value of from 1 to 4.

### Quaternary Phosphonium Compounds

In certain embodiments, the tetrahydrocarbyl phosphonium salts comprise trihydrocarbyl alkyl phosphonium salts or mixtures of trihydrocarbyl alkyl phosphonium salts represented by the formula:

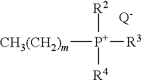

where m is an integer having a value between 6 and 40, R², R³, R⁴, and Q⁻ are as previously defined. In other embodiments, the trihydrocarbylalkylphosphonium salt comprises dodecyltrimethyl phosphonium chloride, hexadecyl trimethyl phosphonium hydroxide, hexadecyl trimethyl phosphonium acetate, cocoalkyltrimethylphosphonium chloride, hexadecyltrimethyl phosphonium chloride, tallowalkyltrimethyl phosphonium chloride, C₁₂-C₁₆ alkyl dimethyl benzyl phosphonium chloride, C₁₂-C₁₆ alkyl dimethyl ethyl phosphonium ethoxysulfate, di(octadecyl-hexadecyl)dimethyl phosphonium chloride, and mixtures or combinations thereof. In other embodiments, the trihydrocarbylalkylphosphonium salt comprises dodecyltrimethyl phosphonium chloride or C₁₂-C₁₆ alkyl dimethyl benzyl phosphonium chloride. In other embodiments, the trihydrocarbylalkylphosphonium salt comprises cocoalkyltrimethylphosphonium chloride. In other embodiments, the trihydrocarbylalkylphosphonium salt comprises hexadecyltrimethyl phosphonium chloride. In other embodiments, the trimethylalkylphosphonium salt comprises tallowalkyltrimethyl phosphonium chloride.

In certain embodiments, the tetrahydrocarbyl phosphonium salts comprise dihydrocarbyl dialkyl phosphonium salts or mixtures of dihydrocarbyl dialkyl phosphonium salts represented by the formula:

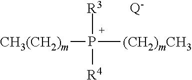

where each m is an integer having a value between 6 and 40, R³, R⁴, and Q⁻ are as previously defined. In other embodiments, the dihydrocarbyldialkylphosphonium salt comprises didodecyldimethyl phosphonium chloride, dicocoalkyldimethylphosphonium chloride, dihexadecyldimethyl phosphonium chloride, ditallowalkyldimethyl phosphonium chloride, and mixtures or combinations thereof.

In certain embodiments, the tetrahydrocarbyl phosphonium salts are amido trihydrocarbyl phosphonium salts represented by the following formula:

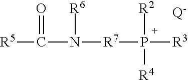

where R², R³, R⁴, and Q⁻ are as previously defined, R⁵ is a hydrocarbyl group having between 1 and 80 carbon atoms, R⁶ is a hydrogen atom or a hydrocarbyl group having between 1 and 80 carbon atoms, and R⁷ is a linking group having between 1 and 10 carbon atoms. Exemplary examples include, without, limitation, oleylamidopropyltrimethyl phosphonium chloride, laurylamidopropyltrimethyl phosphonium chloride, cocoamidopropyltrimethyl phosphonium chloride, cocoamidopropyldimethyl benzyl phosphonium chloride, cocoamidopropyldimethylethyl phosphonium ethoxysulfate are examples of hydrocarbylamidopropyltrialkyl phosphonium quaternaries.

In certain embodiments, the quaternary phosphonium compounds comprise diphosphonium salts represented by the formula:

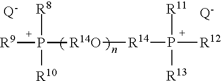

where R⁸, R⁹, R¹⁰, R¹¹, R¹², and R¹³ are independently hydrocarbyl group having between 1 and 80 carbon atoms, R¹⁴ is a linking group having between 1 and 4 carbon atoms, and Q⁻ is as previously defined, and n is an integer having a value of from 1 to 4.

In all of the hydrocarbyl groups defined above, one or more of the carbon atoms may be replaced by hetero atoms or hetero atom containing groups selected from the group consisting of: (1) a boron atom in the form of a borane group, (2) a nitrogen atom in the form of an amino group, (3) a nitrogen-containing group in the form of an amido group, an imino group, an imido group, an urea group, or mixtures thereof, (4) an oxygen atom in the form of an ether group, (5) an oxygen-containing group in the form of a carbonate group, an aldehyde group, a keto group or mixtures thereof, (6) a phosphorus atom in the form of a phosphine, (7) a phosphorus-containing group in the form of a phosphonate, phosphinate, or mixtures thereof, (8) a sulfur atom in the form of a sulfide group, (9) a sulfur-containing group in the form of a thio keto group, thio carbonate group, or mixtures thereof, and (10) mixtures or combinations thereof.

In all of the hydrocarbyl groups defined above, one or more of the hydrogen atoms may be replaced by hetero atoms or groups selected from the group consisting of: (1) halide atoms (F, Cl, Br, and/or I), (2) groups including hydroxy groups, alkoxy groups, amido groups, thiol groups, and mixtures thereof, and (3) mixtures or combinations thereof.

### Suitable Reagents

### Anti-Gel Agents

Suitable anti-gelling agents include, without limitation, quaternary ammonium compounds, quaternary phosphonium compounds, or mixtures and combinations thereof. In certain embodiments, the quaternary ammonium compounds and quaternary phosphonium compounds include tetrahydrocarbyl ammonium salts, tetrahydrocarbyl phosphonium salts, trihydrocarbyl alkyl ammonium salts, trihydrocarbyl alkyl phosphonium salts, dihydrocarbyl dialkyl ammonium salts, dihydrocarbyl dialkyl phosphonium salts, trihydrocarbyl amido ammonium salts, trihydrocarbyl amido phosphonium salts, diammonium salts, diphosphonium salts, or mixtures and combinations thereof.

### Tetrahydrocarbyl Ammonium Salts

Suitable tetrahydrocarbyl ammonium salts include compounds of the general formula:

R¹R²R³R⁴N⁺Q⁻

where R¹, R², R³, and R⁴ are the same or different hydrocarbyl groups having between 1 and 80 carbon atoms, where at least one of the hydrocarbyl groups has at least 8 carbon atoms and where Q⁻ is a halide (e.g., fluoride, chloride, bromide, and iodide), a CH₃SO₄⁻ group, a CH₃CH₂SO₄⁻ group, a hydroxide ion (OH⁻), an acetate ion (OAc⁻), or mixtures and combinations thereof. Exemplary examples are dodecyltrimethyl ammonium chloride, hexadecyl trimethyl ammonium hydroxide, hexadecyl trimethyl ammonium acetate, cocoalkyltrimethylammonium chloride, hexadecyltrimethyl ammonium chloride, tallowalkyltrimethyl ammonium chloride, C₁₂-C₁₆ alkyl dimethyl benzyl ammonium chloride, C₁₂-C₁₆ alkyl dimethyl ethyl ammonium ethoxysulfate, di(octadecyl-hexadecyl)dimethyl ammonium chloride, di(C₁₂-C₁₆ alkyldimethylamine) diethyl ether dichloride, tricaprylmethyl ammonium chloride, tributylhexadecylammonium bromide and trihexyltetradecyl ammonium chloride, tributyl(tetradecyl) ammonium chloride; tributyldodecyl ammonium bromide, tetrabutyl ammonium bromide, tetrabutyl ammonium chloride, decyltriphenyl ammonium bromide, dodecyltriphenyl ammonium bromide, tetrakis(hydromethyl)ammonium chloride, and mixtures thereof. Tributyl(tetradecyl)ammonium chloride is available from Cytex as Cyphos IL 167. Aliquat HTA-1 is a water soluble, quaternary ammonium salt that is a 30-35% active and is a high-temperature phase transfer catalyst.

### Trihydrocarbyl Alkyl Ammonium Salts

Suitable trihydrocarbyl alkyl ammonium salts include compounds of the formula:

(CH₃(CH₂)ₘ)R²R³R⁴N⁺Q⁻

where R², R³, R⁴, and Q⁻ are previously defined and m is an integer having a value between 6 to 22.

### Dihydrocarbyl Dialkyl Ammonium Salts

Suitable dihydrocarbyl dialkyl ammonium salts include compounds of the formula:

(CH₃(CH₂)ₘ)₂R³R⁴N⁺Q⁻

where R³, R⁴, and Q⁻ are previously defined and each m is independently an integer having a value between 6 to 22.

### Hydrocarbyl Trialkyl Ammonium Salts

Suitable hydrocarbyl trialkyl ammonium salts include compounds of the formula:

(CH₃(CH₂)ₘ)₃R⁴N⁺Q⁻

where R⁴ and Q⁻ are previously defined and each m is independently an integer having a value between 6 to 22.

### Trihydrocarbyl Methyl Ammonium Salts

Suitable trihydrocarbyl methyl ammonium salts include compounds of the general formula:

R²R³R⁴Me₂N⁺Q⁻

where R², R³, R⁴ and Q⁻ are as previously defined.

### Dihydrocarbyl Dimethyl Ammonium Salts

Suitable dihydrocarbyl dimethyl ammonium salts include compounds of the general formula:

R³R⁴Me₂N⁺Q⁻

where R³, R⁴ and Q⁻ are as previously defined. Exemplary examples include, without limitation, C₁₂-C₁₆ alkyl dimethyl benzyl ammonium chloride, C₁₆-C₁₈-alky dimethyl ammonium ethoxysulfate, or mixtures and combinations thereof. These quaternaries are manufactured by reacting dimethylalkylamine with methyl chloride, benzyl chloride, benzyl bromide, acetic acid, dimethyl sulfate, diethyl sulfate, dichloroethylether, or their mixtures. Suitable dimethylalkylamines include compounds manufactured by Kao such as Farmin DM24C, DM2098, DM4098, DM2280, DM2467, DM8665, mixtures thereof and others. Weatherford International manufacturers benzyl chloride quaternary salts of C₁₂-C₁₆ alkyldimethylamine such as IC-152 and IC-153, and the dichloroethylether quaternary salts of C₁₂-C₁₆ alkyl dimethylamine as IC-170. Another quaternary amine of this invention is didecyldimethyl ammonium chloride. Didecyldimethyl ammonium chloride is manufactured by Feixiang Chemicals Co, LTD.

### Hydrocarbyl Trimethyl Ammonium Salts

Suitable hydrocarbyl trimethyl ammonium salts or trimethyl hydrocarbyl ammonium salts include compounds of the general formula:

R⁴Me₃N⁺Q⁻

where R⁴ and Q⁻ are as previously defined.

Exemplary examples of trimethylhydrocarbylammonium salts include, without limitation, alkyl trimethyl ammonium chlorides, mixtures of alkyl trimethyl ammonium chlorides, alkyl trimethyl ammonium bromides, alkyl trimethyl ammonium hydroxides, mixtures of alkyl tirmethyl ammonium hydroxides, alkyl trimethyl ammonium acetates, mixtures of alkyl trimethyl ammonium acetates, where the alkyl group includes from about 8 carbon to 60 carbon atoms. Exemplary examples of alkyl trimethyl ammonium chlorides, bromides, hydroxides, and acetates include, without limitation, dodecyl trimethyl ammonium hydroxide, dodecyl trimethyl ammonium acetate, nonyltrimethyl ammonium chloride, decyltrimethyl ammonium chloride, undecyltrimethyl ammonium chloride, dodecyltrimethyl ammonium chloride, tridecyltrimethyl ammonium chloride, tetradecyltrimethyl ammonium chloride, pentadecyltrimethyl ammonium chloride, hexadecyltrimethyl ammonium chloride, cocoalkyl trimethyl ammonium chloride, heptadecyltrimethyl ammonium chloride, tallowalkyltrimethyl ammonium chloride, octadecyltrimethyl ammonium chloride, nonadecyltrimethyl ammonium chloride, icosyltrimethyl ammonium chloride, heneicosyltrimethyl ammonium chloride, docosyltrimethyl ammonium chloride, tricosyltrimethyl ammonium chloride, tetracosyltrimethyl ammonium chloride, pentacosyltrimethyl ammonium chloride, hexacosyltrimethyl ammonium chloride, heptacosyltrimethyl ammonium chloride, octacosyltrimethyl ammonium chloride, nonacosyltrimethyl ammonium chloride, triacontyltrimethyl ammonium chloride, hentriacontyltrimethyl ammonium chloride, dotriacontyltrimethyl ammonium chloride, tritriacontyltrimethyl ammonium chloride, tetratriacontyltrimethyl ammonium chloride, pentatriacontyltrimethyl ammonium chloride, hexatriacontyltrimethyl ammonium chloride heptatriacontyltrimethyl ammonium chloride, octatriacontyltrimethyl ammonium chloride, nonatriacontyltrimethyl ammonium chloride, tetracontyltrimethyl ammonium chloride, hentetracontyltrimethyl ammonium chloride, dotetracontyltrimethyl ammonium chloride triatetracontyltrimethyl ammonium chloride, tetratetracontyltrimethyl ammonium chloride, pentatetracontyltrimethyl ammonium chloride, hexatetracontyltrimethyl ammonium chloride, heptatetracontyltrimethyl ammonium chloride, octatetracontyltrimethyl ammonium chloride, nonatetracontyltrimethyl ammonium chloride, pentacontyltrimethyl ammonium chloride, henpentacontyltrimethyl ammonium chloride, dopentacontyltrimethyl ammonium chloride, tripentacontyltrimethyl ammonium chloride, tetrapentacontyltrimethyl ammonium chloride, higher alkyl group trimethyl ammonium chlorides, nonyltrimethyl ammonium bromide, decyltrimethyl ammonium bromide, undecyltrimethyl ammonium bromide, dodecyltrimethyl ammonium bromide, tridecyltrimethyl ammonium bromide, tetradecyltrimethyl ammonium bromide, pentadecyltrimethyl ammonium bromide, hexadecyltrimethyl ammonium bromide, heptadecyltrimethyl ammonium bromide, octadecyltrimethyl ammonium bromide, nonadecyltrimethyl ammonium bromide, icosyltrimethyl ammonium bromide, heneicosyltrimethyl ammonium bromide, docosyltrimethyl ammonium bromide, tricosyltrimethyl ammonium bromide, tetracosyltrimethyl ammonium bromide, pentacosyltrimethyl ammonium bromide, hexacosyltrimethyl ammonium bromide, heptacosyltrimethyl ammonium bromide, octacosyltrimethyl ammonium bromide, nonacosyltrimethyl ammonium bromide, triacontyltrimethyl ammonium bromide, hentriacontyltrimethyl ammonium bromide, dotriacontyltrimethyl ammonium bromide, tritriacontyltrimethyl ammonium bromide, tetratriacontyltrimethyl ammonium bromide, pentatriacontyltrimethyl ammonium bromide, hexatriacontyltrimethyl ammonium bromide heptatriacontyltrimethyl ammonium bromide, octatriacontyltrimethyl ammonium bromide, nonatriacontyltrimethyl ammonium bromide, tetracontyltrimethyl ammonium bromide, hentetracontyltrimethyl ammonium bromide, dotetracontyltrimethyl ammonium bromide triatetracontyltrimethyl ammonium bromide, tetratetracontyltrimethyl ammonium bromide, pentatetracontyltrimethyl ammonium bromide, hexatetracontyltrimethyl ammonium bromide, heptatetracontyltrimethyl ammonium bromide, octatetracontyltrimethyl ammonium bromide, nonatetracontyltrimethyl ammonium bromide, pentacontyltrimethyl ammonium bromide, henpentacontyltrimethyl ammonium bromide, dopentacontyltrimethyl ammonium bromide, tripentacontyltrimethyl ammonium bromide, tetrapentacontyltrimethyl ammonium bromide, higher alkyl group trimethyl ammonium bromides, and mixtures or combinations thereof. In certain embodiments, the anti-gelling agents include, without limitation, dodecyltrimethyl ammonium chloride such as Arquad 12-50H, cocoalkyltrimethyl ammonium chloride such as Arquad C-50, hexadecyltrimethyl ammonium chloride such as Arquad 16-50, tallowalkyltrimethyl ammonium chloride such as Arquad T-50, and mixtures or combinations thereof. These alkyltrimethyl ammonium chlorides are available from AkzoNobel. In another embodiment, the anti-gelling agents include, without limitation, C12-C₁₆ alkyldimethyl benzyl ammonium chloride such as IC-152 and IC-153 and mixtures thereof or combinations. These dimethyldihydrocarbyl ammonium salts are manufactured by Weatherford or Clearwater International. In certain embodiments, the anti-gelling agent includes dodecyltrimethylammonium chloride and/or cocoalkyltrimethyl ammonium chloride.

### Trihydrocarbyl Amido Ammonium Salts

Suitable amidotrihydrocarbyl ammonium salts include compound the following formula:

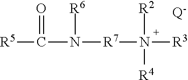

where R², R³, R⁴, and Q⁻ are as previously defined, R⁵ is a hydrocarbyl group having between 1 and 80 carbon atoms, R⁶ is a hydrogen atom or a hydrocarbyl group having between 1 and 80 carbon atoms, and R⁷ is a linking group having between 1 and 10 carbon atoms. Exemplary examples include, without, limitation, oleylamidopropyltrimethyl ammonium chloride, laurylamidopropyltrimethyl ammonium chloride, cocoamidopropyltrimethyl ammonium chloride, cocoamidopropyldimethyl benzyl ammonium chloride, cocoamidopropyldimethylethyl ammonium ethoxysulfate are examples of hydrocarbylamidopropyltrialkyl ammonium quaternaries.

### Diammonium Salts

Suitable diammonium salts includes compounds of the general formula:

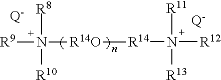

where R⁸, R⁹, R¹⁰, R¹¹, R¹², R¹³, Q⁻, and m are as previously defined. An example of a diquaternary is the reaction product of dichloroethylether and DM4250M or DM2470N manufactured by Weatherford International such as IC-170.

Suitable dialkyl diammonium salts includes compounds of the general formula:

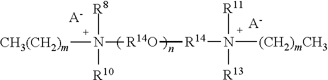

where R⁸, R¹⁰, R¹¹, R¹³, Q⁻, and m are as previously defined. An example of a diquaternary is the reaction product of dichloroethylether and DM4250M or DM2470N manufactured by Weatherford International such as IC-170.

### Tetrahydrocarbyl Phosphonium Salts

Suitable tetrahydrocarbyl phosphonium salts include compounds of the general formula:

R¹R²R³R⁴P⁺Q⁻

where R¹, R², R³, and R⁴ are the same or different hydrocarbyl groups having between 1 and 80 carbon atoms, where at least one of the hydrocarbyl groups has at least 8 carbon atoms and where Q⁻ is a halide (e.g., fluoride, chloride, bromide, and iodide), a CH₃SO₄⁻ group, a CH₃CH₂SO₄⁻ group, a hydroxide ion (OH⁻), an acetate ion (OAc⁻), or mixtures and combinations thereof. Exemplary examples of tetra hydrocarbylphosphonium salts include, without limitation, tributylhexadecylphosphonium bromide, trihexyltetradecyl phosphonium chloride and tributyltetradecyl phosphonium chloride, hexadecyl trimethyl phosphonium hydroxide, and hexadecyl trimethyl phosphonium acetate. Tributyltetradecyl phosphonium chloride is available from Cytex as Cyphos™ IL 167.

### Trihydrocarbyl Alkyl Phosphonium Salts

Suitable trihydrocarbyl alkyl phosphonium salts include compounds of the formula:

(CH₃(CH₂)ₘ)R²R³R⁴P⁺Q⁻

where R², R³, R⁴, and Q⁻ are previously defined and m is an integer having a value between 6 to 22. In certain embodiments, R¹ and R² are independently alkyl, alkenyl and hydroxyalkyl having from 1 to 22 carbons, R³ is benzyl, alkyl or alkenyl and hydroxyalkyl from 1 to 12 carbons, m is an integer having a value between 8 and 22, Q⁻ is chloride, bromide, CH₃ SO₄⁻, C₂H₅SO₄⁻, hydroxide (OH⁻), or an acetate ion (OAc⁻).

### Dihydrocarbyl Dialkyl Phosphonium Salts

In certain embodiments, the trihydrocarbyl phosphonium salts comprises dialkyl phosphonium salts are compounds of the formula:

(CH₃(CH₂)ₘ)₂R³R⁴N⁺Q⁻

where R³, R⁴, and Q⁻ are previously defined and each m is independently an integer having a value between 6 to 22. Exemplary examples include, without limitation, di-C₁₆-C₁₈-alkydimethyl phosphonium chloride, di(octadecyl-hexadecyl)dimethyl phosphonium chloride, didecyldimethyl phosphonium chloride, or mixtures and combinations thereof.

### Hydrocarbyl Trialkyl Phosphonium Salts

In certain embodiments, the hydrocarbyl trialkyl phosphonium salts are compounds of the formula:

(CH₃(CH₂)ₘ)₃R⁴N⁺Q⁻

where R⁴ and Q⁻ are previously defined and each m is independently an integer having a value between 6 to 22.

### Trihydrocarbyl Methyl Phosphonium Salts

Suitable trihydrocarbyl methyl phosphonium salts include compounds of the general formula:

R²R³R⁴MeP⁺Q⁻

where R², R³, R⁴ and Q⁻ are as previously defined.

### Dihydrocarbyl Dimethyl Phosphonium Salts

Suitable dihydrocarbyl dimethyl phosphonium salts include compounds of the general formula:

R³R⁴Me₂P⁺Q⁻

where R³, R⁴ and Q⁻ are as previously defined.

### Hydrocarbyl Trimethyl Phosphonium Salts

Suitable hydrocarbyl trimethyl phosphonium salts or trimethylcarbylphosphonium salts include compounds of the general formula:

R⁴Me₃P⁺Q⁻

where R⁴ and Q⁻ are as previously defined.

Exemplary examples of trimethylhydrocarbylphosphonium salts include, without limitation, alkyl trimethyl phosphonium chlorides, mixtures of alkyl trimethyl phosphonium chlorides, alkyl trimethyl phosphonium bromides, mixtures of alkyl trimethyl phosphonium bromides, alkyl trimethyl phosphonium hydroxides, mixtures of alkyl trimethyl phosphonium hydroxides, alkyl trimethyl phosphonium acetates, mixtures of alkyl trimethyl phosphonium acetates, where the alkyl group includes from about 8 carbon to 60 carbon atoms. Exemplary examples of alkyl trimethyl phosphonium chlorides, bromides, hydroxides, and acetates include, without limitation, hexadecyl trimethyl phosphonium hydroxide, hexadecyl trimethyl phosphonium acetate, nonyltrimethyl phosphonium chloride, decyltrimethyl phosphonium chloride, undecyltrimethyl phosphonium chloride, dodecyltrimethyl phosphonium chloride, tridecyltrimethyl phosphonium chloride, tetradecyltrimethyl phosphonium chloride, pentadecyltrimethyl phosphonium chloride, hexadecyltrimethyl phosphonium chloride, heptadecyltrimethyl phosphonium chloride, octadecyltrimethyl phosphonium chloride, nonadecyltrimethyl phosphonium chloride, icosyltrimethyl phosphonium chloride, heneicosyltrimethyl phosphonium chloride, docosyltrimethyl phosphonium chloride, tricosyltrimethyl phosphonium chloride, tetracosyltrimethyl phosphonium chloride, pentacosyltrimethyl phosphonium chloride, hexacosyltrimethyl phosphonium chloride, heptacosyltrimethyl phosphonium chloride, octacosyltrimethyl phosphonium chloride, nonacosyltrimethyl phosphonium chloride, triacontyltrimethyl phosphonium chloride, hentriacontyltrimethyl phosphonium chloride, dotriacontyltrimethyl phosphonium chloride, tritriacontyltrimethyl phosphonium chloride, tetratriacontyltrimethyl phosphonium chloride, pentatriacontyltrimethyl phosphonium chloride, hexatriacontyltrimethyl phosphonium chloride heptatriacontyltrimethyl phosphonium chloride, octatriacontyltrimethyl phosphonium chloride, nonatriacontyltrimethyl phosphonium chloride, tetracontyltrimethyl phosphonium chloride, hentetracontyltrimethyl phosphonium chloride, dotetracontyltrimethyl phosphonium chloride triatetracontyltrimethyl phosphonium chloride, tetratetracontyltrimethyl phosphonium chloride, pentatetracontyltrimethyl phosphonium chloride, hexatetracontyltrimethyl phosphonium chloride, heptatetracontyltrimethyl phosphonium chloride, octatetracontyltrimethyl phosphonium chloride, nonatetracontyltrimethyl phosphonium chloride, pentacontyltrimethyl phosphonium chloride, henpentacontyltrimethyl phosphonium chloride, dopentacontyltrimethyl phosphonium chloride, tripentacontyltrimethyl phosphonium chloride, tetrapentacontyltrimethyl phosphonium chloride, higher alkyl group trimethyl phosphonium chlorides, nonyltrimethyl phosphonium bromide, decyltrimethyl phosphonium bromide, undecyltrimethyl phosphonium bromide, dodecyltrimethyl phosphonium bromide, tridecyltrimethyl phosphonium bromide, tetradecyltrimethyl phosphonium bromide, pentadecyltrimethyl phosphonium bromide, hexadecyltrimethyl phosphonium bromide, heptadecyltrimethyl phosphonium bromide, octadecyltrimethyl phosphonium bromide, nonadecyltrimethyl phosphonium bromide, icosyltrimethyl phosphonium bromide, heneicosyltrimethyl phosphonium bromide, docosyltrimethyl phosphonium bromide, tricosyltrimethyl phosphonium bromide, tetracosyltrimethyl phosphonium bromide, pentacosyltrimethyl phosphonium bromide, hexacosyltrimethyl phosphonium bromide, heptacosyltrimethyl phosphonium bromide, octacosyltrimethyl phosphonium bromide, nonacosyltrimethyl phosphonium bromide, triacontyltrimethyl phosphonium bromide, hentriacontyltrimethyl phosphonium bromide, dotriacontyltrimethyl phosphonium bromide, tritriacontyltrimethyl phosphonium bromide, tetratriacontyltrimethyl phosphonium bromide, pentatriacontyltrimethyl phosphonium bromide, hexatriacontyltrimethyl phosphonium bromide heptatriacontyltrimethyl phosphonium bromide, octatriacontyltrimethyl phosphonium bromide, nonatriacontyltrimethyl phosphonium bromide, tetracontyltrimethyl phosphonium bromide, hentetracontyltrimethyl phosphonium bromide, dotetracontyltrimethyl phosphonium bromide triatetracontyltrimethyl phosphonium bromide, tetratetracontyltrimethyl phosphonium bromide, pentatetracontyltrimethyl phosphonium bromide, hexatetracontyltrimethyl phosphonium bromide, heptatetracontyltrimethyl phosphonium bromide, octatetracontyltrimethyl phosphonium bromide, nonatetracontyltrimethyl phosphonium bromide, pentacontyltrimethyl phosphonium bromide, henpentacontyltrimethyl phosphonium bromide, dopentacontyltrimethyl phosphonium bromide, tripentacontyltrimethyl phosphonium bromide, tetrapentacontyltrimethyl phosphonium bromide, higher alkyl group trimethyl phosphonium bromides, and mixtures or combinations thereof. In certain embodiments, the anti-gelling agents include, without limitation, dodecyltrimethyl phosphonium chloride, cocoalkyltrimethyl phosphonium chloride, hexadecyltrimethyl phosphonium chloride, tallowalkyltrimethyl phosphonium chloride, hexadecyl trimethyl phosphonium hydroxide, hexadecyl trimethyl phosphonium acetate, and mixtures or combinations thereof. In certain embodiments, the anti-gelling agent includes dodecyltrimethylphosphonium chloride.

### Trihydrocarbyl Amido Ammonium Salts

Suitable amidotrihydrocarbyl phosphonium salts include compound the following formula:

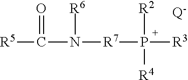

where R², R³, R⁴, and Q⁻ are as previously defined, R⁵ is a hydrocarbyl group having between 1 and 80 carbon atoms, R⁶ is a hydrogen atom or a hydrocarbyl group having between 1 and 80 carbon atoms, and R⁷ is a linking group having between 1 and 10 carbon atoms. Exemplary examples include, without, limitation, oleylamidopropyltrimethyl phosphonium chloride, laurylamidopropyltrimethyl phosphonium chloride, cocoamidopropyltrimethyl phosphonium chloride, cocoamidopropyldimethyl benzyl phosphonium chloride, cocoamidopropyldimethylethyl phosphonium ethoxysulfate are examples of hydrocarbylamidopropyltrialkyl phosphonium quaternaries.

### Diphosphonium Salts

Suitable diphosphonium salts includes compounds of the general formula:

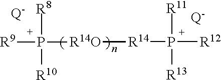

where R⁸, R⁹, R¹⁰, R¹¹, R¹², R¹³, Q⁻, and m are as previously defined.

Suitable dialkyl diphosphonium salts includes compounds of the general formula:

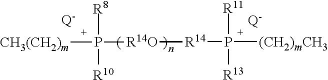

where R⁸, R¹⁰, R¹¹, R¹³, Q⁻, and m are as previously defined.

### Polyhydroxyetheramines (PHEAs) and Copolyhydroxyetheramines (CPHEAs)

Suitable polyhydroxyetheramines include, without limitation, polymers and copolymers of diglycidyl ethers (diepoxy ethers) and amines and mixtures or combinations thereof. In certain embodiments, the polymers and copolymers of diglycidyl ethers (diepoxy ethers) and amines are given by the formula:

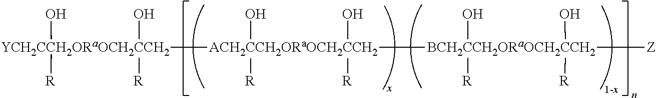

where:

R is independently selected from hydrogen and C₁-C₂₀ alkyl group;

R^{a} is individually selected from an aromatic moiety and a substituted aromatic moiety;

Y is an organic moiety that does not contain an epoxy group;

Z is an organic moiety optionally containing an epoxy group;

n is 5-400;

x is about 0.01 to about 0.99;

A is individually selected from an amino group represented by one of the following formulas:

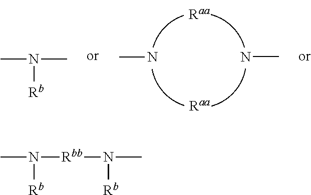

where:
R^{b} is independently selected from hydrocarbyl and substituted hydrocarbyl;
R^{aa} is independently selected from C₂-C₁₀ hydrocarbylene or substituted hydrocarbylene;
R^{bb} is independently selected from C₂-C₂₀ hydrocarbylene group and substituted hydrocarbylene group; and the substituent(s) is independently selected from the group consisting of a hydroxyl group, a cyano group, a halogen, aryloxy group, alkylamido group, arylamido group, alkycarbonyl group, and/or arylcarbonyl group; and

B is represented by the formula:

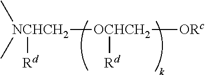

where:
R^{e} is hydrocarbyl group;
R^{d} is independently selected from the group consisting of hydrogen and hydrocarbyl group; and
k is an integer having a value between 1 and 1000.

In another embodiment, the molar ratio of propylene oxide to ethylene oxide is approximately 3/19 or approximately 10/32; and k is a number yielding an approximate molecular weight between 1000 and 2000. In other embodiments, the Y and Z groups are EO to PO mole ratio and molecular weight as described in greater detail in U.S. Pat. Nos. 5,275,853; 5,464,924; 7,417,011; and 7,893,136, which are incorporated by reference via action of the last paragraph of the specification.

The polyhydroxyetheramines (PHEAs) and copolyhydroxyetheramines (CPHEAs) of the present invention may be prepared by reacting (1) a primary amine, a bis(secondary) diamine, or a mono-amine-functionalized poly(alkylene oxide) or mixtures thereof with (2) a diglycidyl ether or a diepoxy-functionalized poly(alkylene oxides) under conditions sufficient to cause the amine moieties to react with the epoxy moieties to form a polymer backbone having amine linkages, ether linkages and pendant hydroxyl moieties as described in greater detail in U.S. Pat. Nos. 5,275,853; 5,464,924; 7,417,011; and 7,893,136, which are incorporated by reference via action of the last paragraph of the specification.

### Polyhydroxyetheramines (PHEAs)

Suitable polyhydroxyetheramines are prepared by contacting one or more diglycidyl ethers of a dihydric phenol with an amine having two amine hydrogens under conditions sufficient to cause the amine moieties to react with epoxy moieties to form a polymer backbone having amine linkages, ether linkages and pendant hydroxyl moieties. Conditions conventionally employed in the reaction of diglycidyl ethers with amines to form amine linkages and pendant hydroxyl groups are suitably employed in preparing the resins of this invention. Examples of such suitable conditions are set forth in U.S. Pat. No. 3,317,471, which is hereby incorporated by reference in its entirety. In general, however, the process for preparing the polymers including the copolymers is carried out so that the unreacted epoxy groups in the finished polyether are minimized. By minimizing the epoxy groups in the polyetheramine, the essential thermoplastic character of the polyetheramine may be retained.

### Copolvhydroxvetheramines (CPHEAs)

Suitable copolyhydroxyetheramines are prepared by contacting one or more diglycidyl ethers of a dihydric phenol with a dihydric phenol and an amine having two amine hydrogens under conditions sufficient to cause the amine moieties to react with epoxy moieties to form a polymer backbone having amine linkages, ether linkages and pendant hydroxyl moieties. In certain conditions, a mixture of the diglycidyl ether(s), amine(s) and dihydric phenol(s) are subjected to copolymerization conditions. In other embodiments, a staged addition procedure is used where the dihydric phenol is added before the amine is introduced or after essentially all of the amine has reacted with the diglycidyl ether. In certain embodiments, where the reaction of dihydric phenol with diglycidyl ether is desired, conditions are employed to promote such reactions such as described in U.S. Pat. No. 4,647,648, which is hereby incorporated by reference in accord with the closing paragraph of the specification.

### Diglycidyl Ethers

The term “diglycidyl ether” means a reaction product of an aromatic, aliphatic, or poly(alkylene oxide) diol with epichlorohydrin.

Suitable diglycidyl ethers of the dihydric phenols include, without limitation, diglycidyl ethers of resorcinol, hydroquinone, 4,4′-isopropylidene bisphenol (bisphenol A), 4,4′-dihydroxydiphenylethylmethane, 3,3′-dihydroxydiphenyldiethylmethane, 3,4′-dihydroxydiphenylmethylpropylmethane, 4,4′-dihydroxydiphenyloxide, 4,4′-dihydroxydiphenylcyanomethane, 4,4′-dihydroxybiphenyl, 4,4′-dihydroxybenzophenone (bisphenol-K), 4,4′-dihydroxydiphenyl sulfide, 4,4′-dihydroxydiphenyl sulfone, 2,6-dihydroxynaphthalene, 1,4′-dihydroxy-naphthalene, catechol, 2,2-bis(4-hydroxyphenyl)-acetamide, 2,2-bis(4-hydroxyphenyl)ethanol, 2,2-bis(4-hydroxyphenyl)-N-methylacetamide, 2,2-bis(4-hydroxy-phenyl)-N,N-dimethylacetamide, 3,5-dihydroxyphenyl-acetamide, 2,4-dihydroxyphenyl-N-(hydroxyethyl)-acetamide, and other dihydric phenols listed in U.S. Pat. Nos. 3,395,118, 4,438,254 and 4,480,082 which are hereby incorporated by reference in accord with the closing paragraph of the specification as well as mixtures of one or more of such diglycidyl ethers. In certain embodiments, the diglycidyl ethers include, without limitation, diglycidyl ethers of bisphenol-A, hydroquinone, and resorcinol. In other embodiments, the diglycidyl ethers are diglycidyl ethers of bisphenol-A.

Diglycidyl ethers which can be employed in the practice of the present invention for preparing the polymers include the diglycidyl ethers of the amide-containing bisphenols such as N,N′-bis(hydroxyphenyl)alkylenedicarboxamides, N,N′-bis(hydroxyphenyl)arylenedicarboxamides, bis(hydroxybenzamido)alkanes or bis(hydroxybenzamido)arenes, N-(hydroxyphenyl)hydroxybenzamides, 2,2-bis(hydroxyphenyl)acetamides, N,N′-bis(3-hydroxyphenyl)glutaramide, N,N′-bis(3-hydroxyphenyl) adipamide, 1,2-bis(4-hydroxybenzamido)ethane, 1,3-bis(4-hydroxybenzamide)benzene, N-(4-hydroxyphenyl)-4-hydroxybenzamide, and 2,2-bis(4-hydroxyphenyl)-acetamide, 9,9-bis(4-hydroxyphenyl)fluorene, 4,4′-methylene bisphenol (bisphenol F), hydroquinone, resorcinol, 4,4′-sulfonyldiphenol, 4,4′-thiodiphenol, 4,4′-oxydiphenol, 4,4′-dihydroxybenzophenone, tetrabromoisopropylidenebisphenol, dihydroxy dinitrofluorenylidenediphenylene, 4,4′-biphenol, 4,4′-dihydroxybiphenylene oxide, bis(4-hydroxyphenyl)methane, a,a-bis(4-hydroxyphenyl)ethylbenzene, 2,6-dihydroxynaphthalene and 4,4′-isopropylidene bisphenol (bisphenol A). More preferred diglycidyl ethers are the diglycidyl ethers of 9,9-bis(4-hydroxyphenyl)fluorene, hydroquinone, resorcinol, 4,4′-sulfonyldiphenol, 4,4′-thiodiphenol, 4,4′-oxydiphenol, 4,4′-dihydroxybenzophenone, bisphenol F, tetrabromoisopropylidenebisphenol, dihydroxy dinitrofluorenylidenediphenylene, 4,4′-biphenol, 4,4′-dihydroxybiphenylene oxide, bis(4-hydroxyphenyl)methane, α,α-bis(4-hydroxyphenyl)ethyl-benzene, 2,6-dihydroxynaphthalene and 4,4′-isopropylidene bisphenol (bisphenol A). Most preferred diglycidyl ethers are the diglycidyl ethers of 4,4′-isopropylidene bisphenol (bisphenol A), 4,4′-sulfonyldiphenol, 4,4′-oxydiphenol, 4,4′-dihydroxybenzophenone, 9,9-bis(4-hydroxy-phenyl)fluorene and bisphenol F.

### Amines

Suitable amines include, without limitation, piperazine and substituted piperazines (e.g., 2-(methylamido)piperazine and dimethylpiperazine); aniline and substituted anilines (e.g., 4-(methylamido)aniline, 4-methoxyaniline, 4-tert-butylaniline, 3,4-dimethoxyaniline and 3,4-dimethylaniline); alkyl amines and substituted alkyl amines (e.g., butylamine and benzylamine); alkanol amines (e.g., 2-aminoethanol and 1-aminopropan-2-ol); and aromatic and aliphatic secondary diamines (e.g., 1,4-bis(methylamino)benzene, 1,2-bis(methylamino)ethane and N,N′-bis(2-hydroxyethyl)ethylenediamine), and mixtures or combinations thereof. In certain embodiments, the amines are 2-aminoethanol and/or piperazine. In other embodiments, the amines are aniline, 4-methoxyaniline, 4-tert-butylaniline, butylamine, and/or 2-aminoethanol. In other embodiments, the amine is 2-aminoethanol.

### Amine Functionalized Polyalkyleneoxides

Amine-functionalized poly(alkylene oxides) which can be employed in the practice of the present invention to prepare the polymers include those materials represented by the general formula:

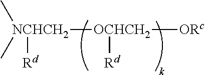

wherein: R^{c} is hydrocarbyl group; R^{d} is independently selected from the group consisting of hydrogen and hydrocarbyl group; and k is from 1 to about 1000. In an embodiment, the molar ratio of propylene oxide to ethylene oxide in the amine-functionalized poly(alkylene oxides) is approximately 3/19 or approximately 10/32; and k is a number yielding an approximate molecular weight of 1000 or 2000.

### Epoxy-Functionalized Polvalkylene Oxides

Epoxy-functionalized poly(alkylene oxides) which can be employed in the practice of the present invention to prepare the polymers include those materials represented by the general formula:

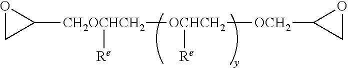

wherein R^{e} is hydrogen, methyl, or mixtures thereof; and y is from about 1 to about 40. Typical of epoxides of this class are the “700” series D.E.R.™ epoxy resins manufactured by The Dow Chemical Company. They are synthesized by polymerizing ethylene oxide, propylene oxide, or mixtures thereof with hydroxide initiators and then reacting the resulting poly(alkylene oxide) diol with epichlorohydrin.

### Monofunctional Nucleophiles

Suitable monofunctional nucleophiles which function as terminating agents include, without limitation, secondary amines, hydrogen sulfide, ammonia, ammonium hydroxide, a hydroxyarene, an aryloxide salt, a carboxylic acid, a carboxylic acid salt, a mercaptan or a thiolate salt. In other embodiments, the hydroxyarene is phenol, cresol, methoxyphenol, and/or 4-tert-butylphenol; the aryloxide salt is sodium and/or potassium phenate; the carboxylic acid is acetic acid and/or benzoic acid; the carboxylic acid salt is sodium acetate, sodium benzoate, sodium ethylhexanoate, potassium acetate, potassium benzoate, potassium ethylhexanoate, and/or calcium ethylhexanoate; the mercaptan is 3-mercapto-1,2-propanediol and/or benzenethiol; and/or the thiolate salt is sodium and/or potassium benzenethiolate.

### Catalysts

Suitable catalysts include, without limitation, metal hydroxides, quaternary ammonium salts and/or quaternary phosphonium salts. In certain embodiments, the catalysts include sodium hydroxide, potassium hydroxide, ammonium hydroxide, ethyltriphenylphosphonium acetate, tetrabutylammonium bromide and/or bis(triphenylphosphoranylidene)ammonium chloride.

### Reaction Conditions

The conditions at which the reaction is most advantageously conducted are dependent on a variety of factors, including the specific reactants, solvent, and catalyst employed but, in general, the reaction is conducted under a non-oxidizing atmosphere such as a blanket of nitrogen. In certain embodiments, the temperature is between about 40° C. and about 190° C. In other embodiments, the temperature between about 50° C. and about 150° C. The reaction may be conducted neat (without solvent or other diluents). However in some cases, in order to ensure homogeneous reaction mixtures at such temperatures, it can be desirable to use inert organic solvents or water as solvent for the reactants. Examples of suitable solvents include dipropylene glycol methyl ether, available commercially as Dowanol™ DPM, a product of The Dow Chemical Company, and the ethers or hydroxy ethers such as diglyme, triglyme, diethylene glycol ethyl ether, diethylene glycol methyl ether, dipropylene glycol methyl ether, propylene glycol phenyl ether, propylene glycol methyl ether and tripropylene glycol methyl ether as well as aprotic amide solvents like 1-methyl-2-pyrrolidinone, N,N-dimethylacetamide, and mixtures thereof.

In certain embodiments, the polyalkylene oxide chain be rich in ethylene oxide relative to propylene oxide. The length of the polyalkylene side-chain may be from 1 alkylene oxide units to 1000 alkylene oxide units. In other embodiments, the length is from 2 alkylene oxide units to 500 alkylene oxide units. In other embodiments, the length is from 5 alkylene oxide units to 250 alkylene oxide units. In other embodiments, the length is from 10 alkylene oxide units to 100 alkylene oxide units.

In certain embodiments, the copolyhydroxyetheramine has a molecular weight of from about 1000 to about 500,000. In other embodiments, the molecular weight is from about 2000 to about 250,000. In other embodiments, the molecular weight is from about 5000 to about 100,000. The copolymer molecular weight may be controlled by either off-stoichiometry of the NH group to epoxy group ratio or by introduction of monofunctional terminating agents, described previously, at the start of the polymerization process or added during or at the end of the polymerization process. Advantageously, the polyalkylene oxide containing polymer repeat units is used in an amount of from about 1 to about 99 mole %, more preferably, in an amount of from about 1 to about 25 mole %. In other embodiments, the copolyhydroxyetheramines have glass transition temperatures of from about (−)60° C. to about 150° C.

The water-soluble polymer may be recovered from the reaction mixture by conventional methods. For example, the reaction mixture containing the polymer and optional solvent can be diluted with a suitable solvent such as dimethylformamide, cooled to room temperature, and the polymer isolated by precipitation into a non-solvent. The precipitated polymer can then be purified by washing or multiple washings by the non-solvent. The polymer is collected by filtration, washed with a suitable non-solvent and then dried. The water-soluble polymer can also be recovered from solution by volatilization of the solvent by combination of temperature and vacuum.

### Other Suitable Reagents

### Water Bases

Suitable aqueous solutions for use in the preparation ofwater-based downhole fluids include, without limitation, fresh water, salt water, brines, or other aqueous solutions including other additives.

### Oil Bases

Suitable base oils include, without limitation, paraffins oils, naphthenic oil, aliphatic solvents and/or oils, aromatic oils, or mixtures and combinations thereof. Exemplary base oils include CALPRINT® 38LP, HYDROCAL® 38, and CONOSOL® C-145 available from Calumet Specialty Products Partners, L.P. of Indianapolis, Ind., RENOIL® 30 available from Renkert Oil of Morgantown, Pa. and BIOBASE® 360 available from Shrieve Chemical Products, Inc., The Woodlands, Tex.

### Surfactants for Inverted Fluids

Suitable primary emulsifiers for use in the formulations of this invention include, without limitation, any primary emulsifying agents used in forming inverted emulsion compositions and muds for use in oil field application. Exemplary examples of primary emulsifiers include, without limitation, fatty acid salts, amidoamine fatty acid salts, and mixtures or combinations thereof. Other suitable primary emulsifier can be found in U.S. Pat. Nos. 4,012,329; 4,108,779; 5,508,258; 5,559,085; 6,608,006; 7,125,826; 7,285,515; and 7,449,846, as set forth in the last paragraph of this application, these references are incorporated by reference in conformity to United States Laws, Rules and Regulations. These references also disclose other secondary emulsifiers that can be used in combination with the new secondary emulsifiers of this invention.

Suitable aromatic compounds include, without limitation, phenol, substituted phenols, hydroxylated naphthalenes, substituted hydroxylated naphthalenes, hydroxylated anthracenes, substituted hydroxylated anthracenes, hydroxylated phenanthrenes, substituted hydroxylated phenanthrenes, hydroxylated chrysenes, substituted hydroxylated chrysenes, hydroxylated pyrenes, substituted hydroxylated pyrenes, hydroxylated corannulenes, substituted hydroxylated corannulenes, hydroxylated coronenes, substituted hydroxylated coronenes, hydroxylated hexahelicenes, substituted hydroxylated hexahelicenes, hetero analogs, where the hetero atom is B, N, O, Si, P, or S and the substituents can be halogen atoms, hydrocarbyl groups (R), alkoxy groups (OR), amino (NRR′), amido groups (CONHR), sulfide groups (SR), silyl groups (SiRR′R″), or the like, and where the hydroxy group is capable of being esterified and mixtures or combinations thereof.

Suitable acid, acid chlorides or anhydrides for use in making the secondary emulsifiers of this invention include, without limitation, Myristoleic acid Palmitoleic acid, Oleic acid, Linoleic acid, α-Linolenic acid, Arachidonic acid, Eicosapentaenoic acid, Erucic acid, Docosahexaenoic acid, Capric acid or Decanoic acid, Undecanoic acid, Lauric acid or Dodecanoic acid, Tridecanoic acid, Myristic acid or Tetradecanoic acid, Palmitic acid or Hexadecanoic acid, Stearic acid or Octadecanoic acid, and Arachidic acid or Eicosanoic acid, their anhydrides and their acid chlorides, and mixtures or combinations thereof.

### Scale Control

Suitable additives for Scale Control and useful in the compositions of this invention include, without limitation: Chelating agents, e.g., Na⁺, K⁺ or NH₄⁺ salts of EDTA; Na, K or NH₄⁺ salts of NTA; Na⁺, K⁺ or NH₄⁺ salts of Erythorbic acid; Na⁺, K⁺ or NH₄⁺ salts of thioglycolic acid (TGA); Na, K or NH₄⁺ salts of Hydroxy acetic acid; Na, K or NH₄⁺ salts of Citric acid; Na, K or NH₄⁺ salts of Tartaric acid or other similar salts or mixtures or combinations thereof. Suitable additives that work on threshold effects, sequestrants, include, without limitation: Phosphates, e.g., sodium hexamethylphosphate, linear phosphate salts, salts of polyphosphoric acid, Phosphonates, e.g., nonionic such as HEDP (hydroxythylidene diphosphoric acid), PBTC (phosphoisobutane, tricarboxylic acid), Amino phosphonates of: MEA (monoethanolamine), NH₃, EDA (ethylene diamine), Bishydroxyethylene diamine, Bisaminoethylether, DETA (diethylenetriamine), HMDA (hexamethylene diamine), Hyper homologues and isomers of HMDA, Polyamines of EDA and DETA, Diglycolamine and homologues, or similar polyamines or mixtures or combinations thereof; Phosphate esters, e.g., polyphosphoric acid esters or phosphorus pentoxide (P₂O₅) esters of: alkanol amines such as MEA, DEA, triethanol amine (TEA), Bishydroxyethylethylene diamine; ethoxylated alcohols, glycerin, glycols such as EG (ethylene glycol), propylene glycol, butylene glycol, hexylene glycol, trimethylol propane, pentaeryithrol, neopentyl glycol or the like; Tris & Tetra hydroxy amines; ethoxylated alkyl phenols (limited use due to toxicity problems), Ethoxylated amines such as monoamines such as MDEA and higher amines from 2 to 24 carbons atoms, diamines 2 to 24 carbons carbon atoms, or the like; Polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof.

### Corrosion Inhibitors

Suitable additives for Corrosion Inhibition and for use in the compositions of this invention include, without limitation: quaternary ammonium salts e.g., chloride, bromides, iodides, dimethylsulfates, diethylsulfates, nitrites, hydroxides, alkoxides, or the like, or mixtures or combinations thereof; salts of nitrogen bases; or mixtures or combinations thereof. Exemplary quaternary ammonium salts include, without limitation, quaternary ammonium salts from an amine and a quaternarization agent, e.g., alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, e.g., alkylpyridines, especially, highly alkylated alkylpyridines, alkyl quinolines, C6 to C24 synthetic tertiary amines, amines derived from natural products such as coconuts, or the like, dialkylsubstituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Exemplary examples of salts of nitrogen bases, include, without limitation, salts of nitrogen bases derived from a salt, e.g.: C₁ to C₈ monocarboxylic acids such as formic acid, acetic acid, propanoic acid, butanoic acid, pentanoic acid, hexanoic acid, heptanoic acid, octanoic acid, 2-ethylhexanoic acid, or the like; C₂ to C₁₂ dicarboxylic acids, C₂ to C₁₂ unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, e.g.: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

### Carbon Dioxide Neutralization

Suitable additives for CO₂ neutralization and for use in the compositions of this invention include, without limitation, MEA, DEA, isopropylamine, cyclohexylamine, morpholine, diamines, dimethylaminopropylamine (DMAPA), ethylene diamine, methoxy proplyamine (MOPA), dimethylethanol amine, methyldiethanolamine (MDEA) & oligomers, imidazolines of EDA and homologues and higher adducts, imidazolines of aminoethylethanolamine (AEEA), aminoethylpiperazine, aminoethylethanol amine, di-isopropanol amine, DOW AMP-90™, Angus AMP-95, dialkylamines (of methyl, ethyl, isopropyl), mono alkylamines (methyl, ethyl, isopropyl), trialkyl amines (methyl, ethyl, isopropyl), bishydroxyethylethylene diamine (THEED), or the like or mixtures or combinations thereof.

### Paraffin Control

Suitable additives for Paraffin Removal, Dispersion, and/or paraffin Crystal Distribution include, without limitation: Cellosolves available from DOW Chemicals Company; Cellosolve acetates; Ketones; Acetate and Formate salts and esters; surfactants composed of ethoxylated or propoxylated alcohols, alkyl phenols, and/or amines; methylesters such as coconate, laurate, soyate or other naturally occurring methylesters of fatty acids; sulfonated methylesters such as sulfonated coconate, sulfonated laurate, sulfonated soyate or other sulfonated naturally occurring methylesters of fatty acids; low molecular weight quaternary ammonium chlorides of coconut oils soy oils or C₁₀ to C₂₄ amines or monohalogenated alkyl and aryl chlorides; quaternary ammonium salts composed of disubstituted (e.g., dicoco, etc.) and lower molecular weight halogenated alkyl and/or aryl chlorides; gemini quaternary salts of dialkyl (methyl, ethyl, propyl, mixed, etc.) tertiary amines and dihalogenated ethanes, propanes, etc. or dihalogenated ethers such as dichloroethyl ether (DCEE), or the like; gemini quaternary salts of alkyl amines or amidopropyl amines, such as cocoamidopropyldimethyl, bis quaternary ammonium salts of DCEE; or mixtures or combinations thereof. Suitable alcohols used in preparation of the surfactants include, without limitation, linear or branched alcohols, specially mixtures of alcohols reacted with ethylene oxide, propylene oxide or higher alkyleneoxide, where the resulting surfactants have a range of HLBs. Suitable alkylphenols used in preparation of the surfactants include, without limitation, nonylphenol, decylphenol, dodecylphenol or other alkylphenols where the alkyl group has between about 4 and about 30 carbon atoms. Suitable amines used in preparation of the surfactants include, without limitation, ethylene diamine (EDA), diethylenetriamine (DETA), or other polyamines. Exemplary examples include Quadrols, Tetrols, Pentrols available from BASF. Suitable alkanolamines include, without limitation, monoethanolamine (MEA), diethanolamine (DEA), reactions products of MEA and/or DEA with coconut oils and acids.

### Oxygen Control

The introduction of water downhole often is accompanied by an increase in the oxygen content of downhole fluids due to oxygen dissolved in the introduced water. Thus, the materials introduced downhole must work in oxygen environments or must work sufficiently well until the oxygen content has been depleted by natural reactions. For system that cannot tolerate oxygen, then oxygen must be removed or controlled in any material introduced downhole. The problem is exacerbated during the winter when the injected materials include winterizers such as water, alcohols, glycols, Cellosolves, formates, acetates, or the like and because oxygen solubility is higher to a range of about 14-15 ppm in very cold water. Oxygen can also increase corrosion and scaling. In CCT (capillary coiled tubing) applications using dilute solutions, the injected solutions result in injecting an oxidizing environment (O₂) into a reducing environment (CO₂, H₂S, organic acids, etc.).

Options for controlling oxygen content includes: (1) de-aeration of the fluid prior to downhole injection, (2) addition of normal sulfides to product sulfur oxides, but such sulfur oxides can accelerate acid attack on metal surfaces, (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Exemplary examples oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents include salicylic and benzoic amides of polyamines, used especially in alkaline conditions, short chain acetylene diols or similar compounds, phosphate esters, borate glycerols, urea and thiourea salts of bisoxalidines or other compound that either absorb oxygen, react with oxygen or otherwise reduce or eliminate oxygen.

### Sulfur Scavenging Agents

The winterized compositions of this invention can also include sulfur scavenging agents provided they are compatible with the compositions. Such sulfur scavenging agents can include those available from Weatherford International, BJ Services, Baker Hughes, Halliburton, other services providers and sulfur scavenger providers. Exemplary examples include those disclosed in U.S. Pat., Pub., or Appln. Nos. 2007-0032693; U.S. Pat. No. 7,140,433; 2005-0137114; U.S. Pat. No. 7,517,447; Ser. No. 12/419,418; 2005-0250666; U.S. Pat. No. 7,268,100; 2008-0039345; 2006-0194700; 2007-0173414; 2007-0129257; U.S. Pat. No. 7,392,847; 2008-0257553; U.S. Pat. No. 7,350,579; Ser. No. 12/075,461; 2007-0173413; 2008-0099207; 2008-0318812; 2008-0287325; 2008-0257556; 2008-0314124; 2008-0269082; 2008-0197085; 2008-0257554; Ser. No. 12/416,984; 2008-0251252; Ser. No. 11/956,433; Ser. No. 12/029,335; Ser. No. 12/237,130; Ser. No. 12/167,087; Ser. No. 12/176,872; 2009-0067931; 2008-0283242; Ser. No. 12/240,987; Ser. No. 12/271,580; Ser. No. 12/364,154; Ser. No. 12/357,556; Ser. No. 12/464,351; or Ser. No. 12/465,437, incorporated by reference per the last paragraph of the specification.

### EXPERIMENTS OF THE INVENTION

### Example 1

This example illustrates the thermal behavior of a PHEA/CPHEA material P1 (XU-19105.00 available from Dow Chemical Company) in the temperature range between 40° C. and 60° C.

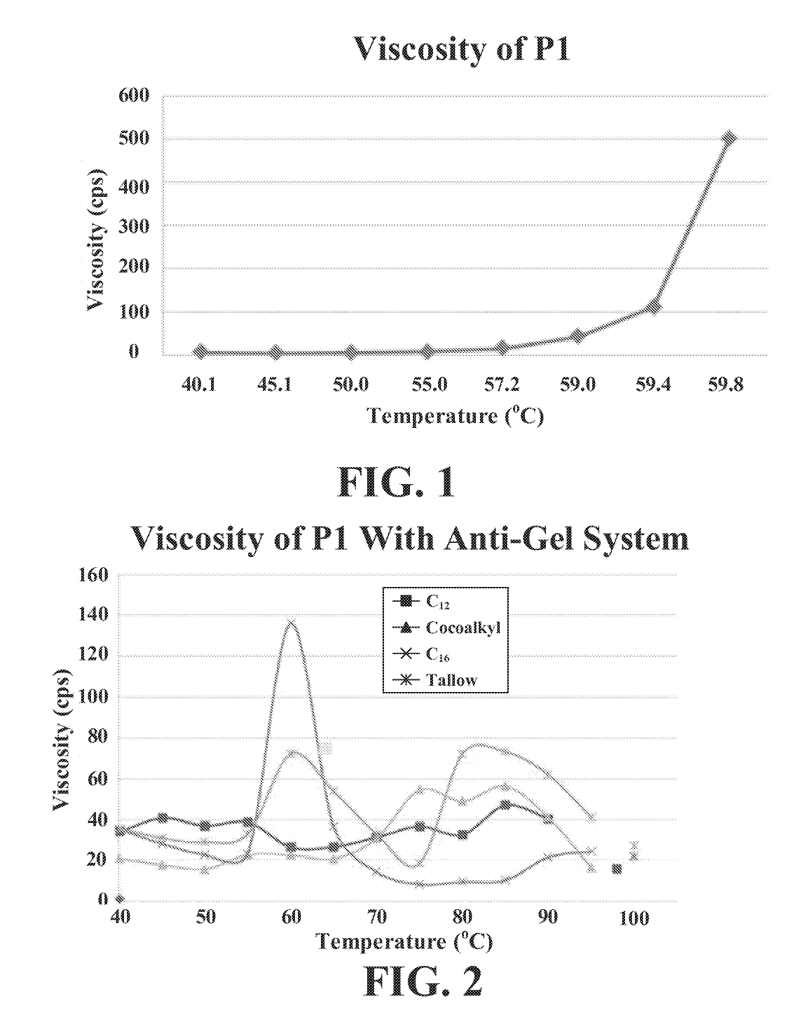

The viscosity exceeded 500 cps at 60 RPM with spindle 31. The RPM was changed to 2 and the viscosity exceeded 9700 cps. The RPM was changed to 0.1 and the viscosity reached 190,000 cps. Therefore, P1 is limited for use as a relative permeation modifier in wells with a temperature less than 55° C. In the oil fields in Texas, South America and the Middle East, temperatures sometimes reach 115° F. to 120° F. and higher which would cause P1 to gel in the drum or tote. The purpose of this invention is to find a material that can be blended with P1 that prevents it from gelling between 46° C. and 62° C. FIG. 1 plots the viscosity behavior of P1 between 40° C. and 60° C., demonstrating that P1 begins to gel at about 55° C. and continues to gel at 59.8° C. reaching a viscosity of about 500 cps.

### Example 2

This examples illustrates the viscosity behavior of a P1 containing composition including four different anti-gel system at a level of 20 grams per 80 grams of a 20 wt. % a P1 aqueous solution. The anti-gel system comprised: (a) dodecyltrimethyl ammonium chloride G1 (Arquad® 12-50H, 50% actives in an isopropanol water solution); (b) cocoalkyltrimethyl ammonium chloride G2 (Arquad® C-50, 50% actives in an isopropanol water solution); (c) hexadecyltrimethyl ammonium chloride G3 (Arquad® 16-50, 50% actives in an isopropanol water solution); and (d) tallowalkyltrimethyl ammonium chloride G4 (Arquad®T-50, 50% actives in an isopropanol water solution) available from AkzoNobel.

20 grams of each of (a) dodecyltrimethyl ammonium chloride G1 (Arquad 12-50H); (b) cocoalkyltrimethyl ammonium chloride G2 (Arquad® C-50); (c) hexaldecyltrimethyl ammonium chloride G3 (Arquad® 16-50); and (d) tallowalkyltrimethyl ammonium chloride G4 (Arquad T-50) were blended with 80 grams of a PHEA/CPHEA solution comprising 20 wt. % P1 in water. The samples were shaken by hand and bubbles were allowed to settle until clear. Viscosity was measured at temperatures between 40° C. to 100° C. at 60 RPM (shear rate of 13.2 s¹) with a DV-III Ultra Programmable Brookfield Rheometer equipped with a small sample adapter and a TC-602 Circulating Bath. The Spindle was No. 31. The results are shown in Table I.

TABLE I
Viscosity Measurements of P1 and Gel Inhibited P1 Systems

| T (° C.) | P1 | P1 + G1 | P1 + G2 | P1 + G3 | P1 + G4 |
|---|---|---|---|---|---|
| 40 | 6.7 | 34 | 20.8 | 35 | 35.5 |
| 45 | 3.75 | 40.75 | 17.7 | 28 | 30.8 |
| 50 | 5.2 | 36.8 | 15.7 | 22.75 | 28.75 |
| 55 | 8 | 38.6 | 22.6 | 23.33 | 33 |
| 57.2 | 15.8 | n.d. | n.d. | n.d. | n.d. |
| 59 | 42.9 | n.d. | n.d. | n.d. | n.d. |
| 59.4 | 111.75 | n.d. | n.d. | n.d. | n.d. |
| 59.8 | 500 | n.d. | n.d. | n.d. | n.d. |
| 60 | n.d. | 26.4 | 22.6 | 136 | 72.16 |
| 65 | n.d. | 26.5 | 20.67 | 36.5 | 53.87 |
| 70 | n.d. | 31.25 | 30.75 | 14.25 | 32.87 |
| 75 | n.d. | 36.5 | 54.5 | 8.17 | 18.5 |
| 80 | n.d. | 32.6 | 48.88 | 9.33 | 72.2 |
| 85 | n.d. | 47 | 56.25 | 10.17 | 73.1 |
| 90 | n.d. | 40.25 | 41 | 21.5 | 61.9 |
| 95 | n.d. | n.d. | 16.25 | 25.5 | 40.9 |
| 98 | n.d. | 15.8 | n.d. | n.d. | n.d. |
| 100 | n.d. | n.d. | 21.8 | 21.8 | 26.9 |

n.d.—no data

FIG. 2 shows that when 20 wt. % of an alkyltrimethyl ammonium chloride is blended with a 20 wt. % a P1 solution in water, the viscosity is below 80 cps from 40° C. to 100° C., except for 136 cps at 60° C. for G3.

The blend of P1 with an alkyltrimethylammonium chloride is used to reduce the water permeability of a well. It decreases the co-production of water with hydrocarbons by reducing the flow of water through hydrocarbon producing formations. It has little or no effect on the permeability of the formation with respect to hydrocarbons. Treatment with the blend of P1 with the alkyltrimethylammonium chloride requires a shut-in to allow for thermal activation (140° F. or higher) of the glass transition phase (Tg). Typically overnight (about 12 hours) is sufficient. The P1 is a low molecular weight of epoxy functionalized with poly(alkylene oxide) with no charge and it is not shear sensitive. When applied to the formation and exposed to the 140° F. activation temperature, it is theorized to form a coating on the rock and clay surfaces. It reduces the permeability of water 5 to 10 times more than it does hydrocarbons.

The blend of P1 with an alkyl trimethyl ammonium chloride can be mixed with a drilling fluid. In certain embodiments, the fluid is a water-based drilling fluid. The blend is added to the drilling fluid in a range of 500 ppm to 10,000 ppm. During normal “leak-off” of drilling fluid into the formation, the P1 is adsorbed into the formation. After shut-in, this leads to a reduction in water permeability.

Alternatively, an oil base drilling fluid can be used. An oil base drilling fluid can comprise an emulsified aqueous phase, thereby allowing the relative permeability composition to be incorporated into the drilling fluid.

The relative permeability composition can be spotted as a pill over a water producing zone after termination of drilling. The pill, comprising an aqueous solution of the relative permeability composition, is squeezed into the formation and drilling is resumed. The relative permeability composition maybe dissolved in an aqueous carrier liquid, comprising fresh water, seawater, or an aqueous salt solution. The aqueous salt solution may comprise potassium chloride, sodium chloride, sodium bromide, sodium acetate, ammonium chloride, and calcium chloride in an amount ranging between about 1% and about 10% by weight of solution. The relative permeability composition is added in a range of 500 ppm to 10,000 ppm of the aqueous carrier liquid.

### Example 3

800.13 grams of P1 and 200.04 grams of G1 (Arquad® 12-50 H from Akzo Nobel) were weighed into a 2000 mL breaker with a magnetic stir bar. P1 was a transparent liquid with a blue tint. The blend was a white semi-transparent liquid with no blue tint.

The beaker and contents were placed on a Corning PC-4200 magnetic stir plate. A temperature probe was inserted into the blend. The temperature probe was plugged into a Dyna sense Thermowatch for digital readout of temperature. The contents were stirred at 300 RPM between 78° F. and 80° F. The contents gradually became more transparent and clearer with stirring. After 23 hours and 27 minutes, the contents were totally transparent and clear with no blue tint.

The polymeric backbone is epoxide based. Because it is epoxide based, it can form a coating on any clay or rock including sandstone, limestone, proppants, and/or proppant pack.

### Example 4

The blend of P1 and G1 from Example 3 was tested in a Formation Response Tester (FRT) manufactured by Chandler Engineering. The blend from Example 3 was loaded into the FRT core holder and a net confining stress of 1500 psi was applied. The ⅛″ flow line was connected and the internal system pressure brought up to 200 psi using 2% KCl while by passing the sample. Heat was applied to the core holder containing Berea Sandstone until a temperature of 175° F. was reached, while confining stress was maintained at 1500 psi.

For all flow measurements made through-out testing, a minimum of five pore volumes of flow was required, however flow was continue until a reasonably stable permeability measurement was reached. Basic sample and treatment properties are summarized in Table II.

TABLE II
Testing Parameters

| CL (cm) | CD (cm) | PV (cc) | T(° F.) | CP (psi) |
|---|---|---|---|---|
| 10.09 | 3.75 | 6.37 | 175 | 1500 |

CL is core lenght;
CD is core diameter,
PV is pore volume,
T is temperature, and
CP is confining pressure

Specific brine permeability was measured with 2% KCl in the production direction at a flow rate of 3 cc/min. for 20 pore volumes and throughput. That insured that the sample reached 100% saturation with brine and served as a reference measurement only.

A second specific brine permeability was measured using API brine in the production direction at a flow rate of 3 cc/min for 10 pore volumes of throughput. This value serves as the initial brine permeability from which to calculate regain permeability.

Ten pore volumes of 0.4% of the blend from Example 3 in 2% KCl was injected in the injection direction at 10 cc/min. Generally, a higher flow rate is preferred for this product as the higher shear rate helps it to coat the grains more effectively. A shut-in period of at least 12 hours is applied directly following treatment.

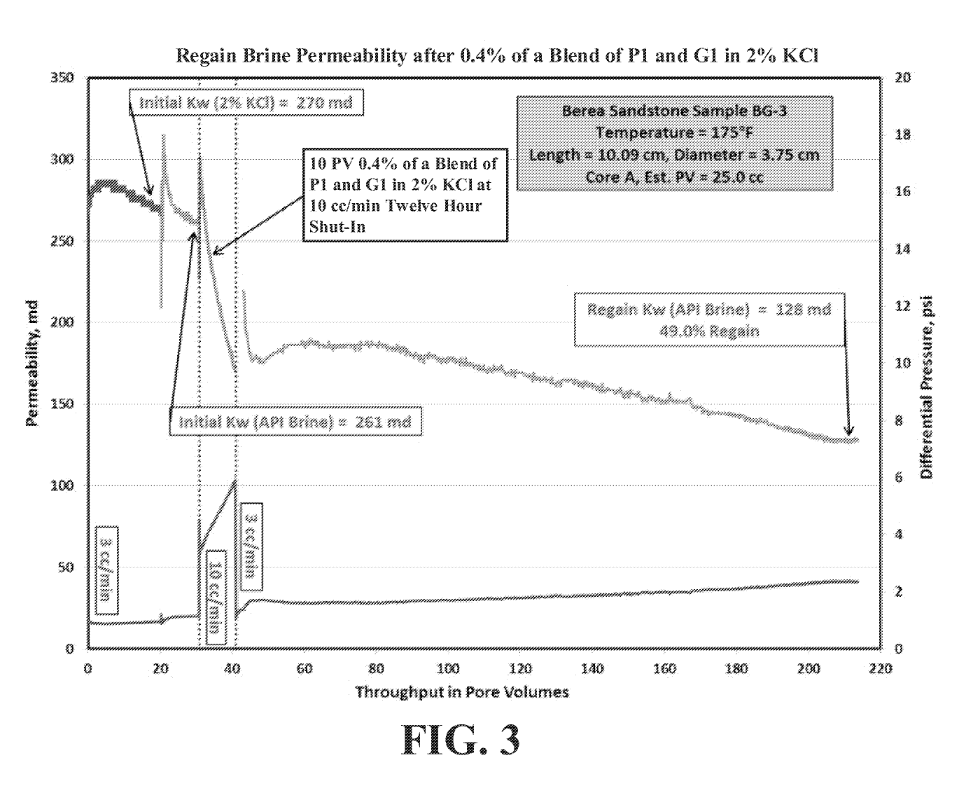

For regain measurement, the system was thoroughly flushed with API brine to remove any residual treatment from the flow system. The regain brine permeability is measured in the production direction at a flow rate of 3 cc/min for 24 hours. Initial Kw (API brine) was 261 md. The regain Kw (API Brine) was 128 md. Final regain permeability was calculated to be 49.0%. The results are also shown in FIG. 3.

### Example 5

This example illustrates the viscosity behavior of the PHEA/CPHEA P1 (XU-19015.00) composition including six different surfactants at a level of approximately either 1 or 10 grams per 80 grams of a 20 wt. % P1 aqueous solution. The surfactants systems comprised (a) 10.08 grams of a benzyl chloride quaternary salt of C₁₂-C₁₆ dimethyl alkylamines in water sold as IC-152w manufactured by Weatherford, G5, (b) 10.04 grams which is a benzyl chloride quaternary salt of C₁₂-C₁₆ dimethyl alkylamines in water and methanol sold as IC-153 manufactured by Weatherford, G6, (c) 1.05 grams of tributylhexadecylphosphonium bromide, G7, (d) 1.03 grams trihexyltetradecyl phosphonium chloride, G8, (e) 10.04 grams tricaprylylmethylammonium chloride sold as Aliquat® HTA-1, G9, (f) 1.06 grams of a diquaternary from the reaction product of dichloroethylether and C₁₂-C₁₆ alkyldimethylamine sold as IC-170 manufactured by Weatherford, G10, (g) 10.12 grams ofIC-170 blended with 80 grams of PHEA/CPHEA solution comprising 20 wt. % P1 in water, G11.

The samples were shaken by hand and allowed to set for more than 24 hours.

G5 and G6 were transparent liquids with no apparent tint. G6 was viscous. When shook, G5 foamed on the surface and G6 did not foam. G7 and G8 were transparent fluids with a gray tint. They foamed on the surface when shaken. G9 was a transparent liquid with a slight white tint. G9 foamed on the surface when shaken. G10 was a transparent liquid with a slight gray tint that foamed on top when shaken. G11 was a transparent liquid that foamed on top when shaken. P1 alone foams when shaken.

Viscosity was measured at temperatures between 40° C. and 100° C. at either 60 RPM (shear Rate of 13.2 s⁻¹) or 1 RPM with a DV III Ultra Programmable Brookfield Rheometer equipped with a small sample adapter and a TC-602 Circulating bath. The desired temperature was set on the TC-602 circulating bath and the viscosity read when the thermocouple on the small sample adapter reached the same temperature as shown in Table III.

TABLE III
Viscosity Measurements of P1 and Gel Inhibited P1 Systems

| T (° C.) | P1 | P1 + G5 | P1 + G6 | P1 + G7 | P1 + G8 | P1 + G9 | P1 + G10 | P1 + G11 |
|---|---|---|---|---|---|---|---|---|
| 40 | 5.25 cp | 18.75 | 157.75 | 10.5 | 8.75 | 4.50 | 10.00 | 9.0 |
| 45 | 4.25 cp | 14.75 | 114.25 | 12.5 | 9.00 | 3.75 | 8.75 | 7.75 |
| 50 | 4.25 | 29.6 | 126.0 | 30.5 | 26.25 | 3.75 | 9.33 | 6.75 |
| 55 | 13.00 | 13.75 | 78.75 | 31.0 | 23.17 | 8.75 | 18.5 | 9.5 |
| 57 | 29.00 | n.d. | n.d. | 30.75 | n.d. | 9.5 | 25.38 | n.d. |
| 58 | 141.5 | n.d. | n.d. | n.d. | n.d. | n.d. | n.d. | n.d. |
| 59 | >500 | n.d. | n.d. | n.d. | n.d. | n.d. | n.d. | n.d. |
| 60 | | 13.8 | 59.5 | 31.8 | 33.5 | 22.7 | 20.38 | 8.0 |
| 65 | | 9.50 | 51.5 | 26.8 | 46.8 | 84.38 | 16.75 | 6.16 |
| 70 | | 9.00 | 52.8 | 48.25 | 52.5 | 73.3 | 11.25 | 13.5 |
| 75 | | 10.50 | 69.7 | 43.7 | 75.88 | 33.25 | 8.75 | 18.5 |
| 80 | | 12.25 | 124.75 | 46.9 | 11.2 | >500 | 12.75 | 21.5 |
| 85 | | 3.5 | 46.7 | 53.3 | 12.00 | 273,376 | 2.75 | 2.5 |
| | | | | | | cp at 1.0 | | |
| | | | | | | RPM | | |
| 90 | | 2.75 | 41.75 | 50.3 | 6.75 | n.d | 2.5 | 3.375 |
| 95 | | 5.25 | 25.0 | 30.3 | 20.75 | n.d. | 3.25 | 6.0 |
| 100 | | 18.6 | 28.75 | 19.75 | 34.67 | n.d. | 12.19 | 5.17 |

n.d.—no data

The viscosities in Table III show that G5, G6, G10, G7, G8, G10 and G11 are very effective as anti-gel agents. G9 is also a good anti-gel agent up to 80° C., but gelled the P1 at 80° C.

### Example 6

This example demonstrates the concentration range of the anti-gel additive for the PHEA/CPHEA P1 (XU-19015.00) composition. The concentration of dodecyltrimethyl ammonium chloride in 50 grams of P1 varied from 0.018% to 10 wt %. Dodecyltrimethyl ammonium chloride was 50% active in isopropanol and water.

The anti-gel additive systems comprised (a) 20.08 grams of a 50% dodecyltrimethyl ammonium chloride in isopropanol and water sold as Arquad® 12-50H, G12, (b) 1.04 grams a 50% dodecyltrimethyl ammonium chloride in isopropanol and water sold as Arquad® 12-50H, G13, (c) 0.1 gram grams a 50% dodecyltrimethyl ammonium chloride in isopropanol and water sold as Arquad® 12-50H, G14, (d) 0.0567 grams of a 50% dodecyltrimethyl ammonium chloride in isopropanol and water sold as Arquad® 12-50H, G15, and (e) 0.0143 grams a 50% dodecyltrimethyl ammonium chloride in isopropanol and water sold as Arquad® 12-50H, G16. The samples were shaken by hand and allowed to set for more than 24 hours.

P1, G12, G13, G14, G15, and G16 were transparent liquids with slight greyish tints that foamed on top when shaken. Their viscosity data is shown Table IV.

TABLE IV
Viscosity Measurements of P1 and Gel Inhibited P1 Systems

| | | P1 + | P1 + | P1 + | P1 + | P1 + |
|---|---|---|---|---|---|---|
| T (° C.) | P1 | G12 | G13 | G14 | G15 | G16 |
| 40 | 5.25 cp | 34 | 8.50 | 6.5 | 4.75 | 5.00 |
| 45 | 4.25 cp | 40.75 | 7.25 | 6.00 | 4.33 | 4.50 |
| 50 | 4.25 | 36.8 | 11.0 | 6.33 | 4.5 | 4.00 |
| 55 | 13.00 | 38.6 | 11.0 | 10.38 | 6.0 | 5.63 |
| 57 | 29.00 | n.d. | 10.75 | 15.38 | 6.5 | 9.5 |
| 58 | 141.5 | n.d. | n.d. | n.d. | n.d. | n.d. |
| 59 | >500 | n.d. | n.d. | n.d. | n.d. | n.d. |
| 60 | | 26.4 | 15.5 | 19.67 | 15.25 | 163.6 |
| 61 | | n.d. | n.d. | n.d. | n.d. | >500 |
| 65 | | 26.5 | 13.75 | 12.5 | 226.4 | |
| 70 | | 31.25 | 10.5 | 26.0 | 25.4 | |
| 75 | | 36.5 | 6.5 | 13.58 | 13.91 | |
| 80 | | 32.6 | 3.75 | 15.4 | 8.1 | |
| 85 | | 47 | 3.1 | 15.75 | 5.5 | |
| 90 | | 40.25 | 2.25 | 19.83 | 36.6 | |
| 95 | | n.d | 1.25 | 28.38 | 37.75 | |
| 100 | | n.d. | 2.75 | 38.67 | 69.25 | |

n.d.—no data

The viscosities in Table IV show that dodecyltrimethyl ammonium chloride is very effective as anti-gel agents in the range of between 0.035 wt. % and 10 wt. %.

### Example 7

This example illustrates the viscosity behavior of compositions including P1 and one of five different surfactants at a level of either 10 or 20 grams per 80 grams of a 20 wt. % P1 aqueous solution. The surfactants systems comprised: (a) 10 grams of a nonionic ethoxylated alcohol surfactant sold as FC PRO Surfactant 425, G17, (b) 20.05 grams of a nonionic ethoxylated alcohol surfactant sold as FC PRO Surfactant 425, G18, (c) 10.00 grams of a nonionic ethoxylated alcohol sold as FC PRO surfactant 450, G19, (d) 10.06 grams of dimethylcocoamine oxide sold as Aromox DMC SR1276554 by Akzo Nobel, G20, (e) 10.09 grams of bis(2-hydroxyethyl) amine oxide sold as Aromox C/12 SR1188278 by Akzo Nobel, G21, (f) 10.08 grams of dimethyl tallow alkyl amine oxide sold as Akzo Nobel Aromox T/12 DPM, G22, blended with 80 grams of P1 solution comprising 20 wt. % P1 in water. The samples were shaken by hand and allowed to set for 24 hours.

G17 was a semi-transparent fluid with a blue tint. G18 was an almost gelled white opaque fluid. After 3 weeks shelf life, G18 dropped out of solution forming two phases; a clear top phase and a white opaque bottom phase, G19 was a semi-transparent fluid with a blue tint. G20 was a gray semi-transparent liquid. G21 was a yellowish gray semi-transparent liquid. G22 was a gray, almost opaque liquid.

Viscosity was measured at temperatures between 40° C. and 100° C. at either 60 RPM (shear Rate of 13.2 s⁻¹) or 1 RPM with a DV III Ultra Programmable Brookfield Rheometer equipped with a small sample adapter and a TC-602 Circulating bath. When the viscosity reached 500 cp, the RPM was switched from 60 to 1 RPM. Any reading above 500 cp was run at 1 RPM. The desired temperature was set on the TC-602 circulating bath and the viscosity read when the thermocouple on the small sample adapter reached the same temperature as shown in Table V.

TABLE V
Viscosity Measurements of P1 and Gel Inhibited P1 Systems

| T (° C.) | P1 | P1 + G17 | P1 + G18 | P1 + G19 | P1 + G20 | P1 + G21 | P1 + G22 |
|---|---|---|---|---|---|---|---|
| 40 | 5.25 cp | 174.5 | 255.4 | 31 | 60.00 | 193.5 | 65.00 |
| 45 | 4.25 cp | 231.5 | 170.5 | 30.75 | 62.0 | 174.25 | 59.0 |
| 50 | 4.25 | 659.9 | 149.5 | 42.5 | 73.75 | 228.0 | 146.75 |
| | | (RPM = 1) | | | | | |
| 55 | 13.00 | 5939 | 126.0 | 275.9 | 116.00 | 929.8 | 14059 |
| | | | | | | (RPM = 1) | (RPM = 1) |
| 57 | 29.00 | n.d. | 141.75 | 1260 | 154.00 | n.d. | n.d. |
| | | | | (RPM = 1) | | | |
| 58 | 141.5 | n.d. | n.d. | 1530 | 200.5 | n.d. | n.d. |
| 59 | >500 | n.d. | 214.0 | 3029 | n.d. | n.d. | n.d. |
| 60 | | 8578 | 180.17 | 4619 | 317.9 | 5309 | 14757 |
| 65 | | 10018 | 151.13 | 7048 | 989.8 | 13707 | 1575 |
| | | | | | (RPM = 1) | | |
| 70 | | 2220 | 57.25 | 4874 | 1695 | 12117 | 1650 |
| 75 | | 539.9 | 41.08 | 4034 | 2280 | 8458 | 1740 |
| 80 | | 479.9 | 113.6 | 195 | 299.9 | 10573 | 734.8 |
| 85 | | 689.9 | 55.4 | 3199 | 389.9 | 1020 | 839.8 |
| 90 | | 944.8 | 437.65 | 2534 | 1890 | 11068 | 1140 |
| 95 | | 839.8 | 328.9 | 1815 | 4709 | 8698 | 1110 |
| 100 | | 644.9 | 273.43 | 1215 | 2235 | 4664 | 4019 |

n.d.—no data

The viscosities tabulated in Table V show that the ethoxylates and amines oxides were not effective as anti-gel agents. The ethoxylates increased the viscosity of the fluid to above 500 cps between 50° C. and 57° C. and maintained the blue tint of the P1. The amine oxides increased the fluid viscosity above 500 cp between 55° C. and 65° C.

### Example 8

This example illustrates the viscosity behavior of the PHEA/CPHEA XU-19015.00 composition including amine oxide, carboxylate, sultaine betaine and ethoxylates.

The viscosity was measured for 7 different surfactants at a level of approximately 1 grams per 80 grams of a 20 wt. % P1 aqueous solution. The surfactants systems comprised (a) 1.00 grams of dimethyl cocoalkylamine oxide sold as Aromox DMC from Akzo Nobel, G23, (b) 1.07 grams of cocamidopropyl betaine sold as Mirtaine BET from Rhodia, G24, (c) 1.21 grams of disodium cocoamphodiacetate sold as Miranol C2M Conc NP, G25, (d) 1.08 grams of cocoamidopropyl hydroxyl sultaine sold as Rhodia Mirataine CBS, G26, (e) 1.07 grams of butyletherhydroxypropyl sultaine sold as Rhodia Mirataine ASC, G27, (f) 1.02 grams of a nonionic ethoxylated alcohol surfactant sold as FC Pro Surfactant 450, G28, and (g) 1.0 grams of a nonionic ethoxylated alcohol surfactant sold as FC Pro Surfactant 425, G29. The samples were shaken by hand and allowed to set for more than 24 hours. All samples in Table VI were transparent with a grey tint and all foamed when shaken.

TABLE VI
Viscosity Measurements of P1 and Gel Inhibited P1 Systems

| T (° C.) | P1 | P1 + G23 | P1 + G24 | P1 + G25 | P1 + G26 | P1 + G27 | P1 + G28 | P1 + G29 |
|---|---|---|---|---|---|---|---|---|
| 40 | 5.25 cp | 5.5 | 5.5 | 5.50 | 5.75 | 4.75 | 6.75 | 6.0 |
| 45 | 4.25 cp | 4.5 | 4.75 | 4.0 | 4.75 | 3.5 | 5.50 | 4.75 |
| 50 | 4.25 | 24.75 | 16.0 | 7.25 | 6.00 | 13.75 | 5.75 | 6.25 |
| 55 | 13.00 | 24.75 | 21.75 | 11.17 | 14.3 | 18.5 | 19.25 | 50.25 |
| 57 | 29.00 | 178.2 | 126.4 | 14.25 | n.d. | 189.2 | >500 | >500 |
| 58 | 141.5 | >500 | >500 | n.d. | n.d. | >500 | | |
| 59 | >500 | | | n.d. | n.d. | | | |
| 60 | | | | 19.0 | >500 | | | |
| 65 | | | | >500 | | | | |

n.d.—no data

The viscosities in Table VI show that the amine oxide, carboxylates, sultaine and ethoxylates were not effective as anti-gel agents.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

1. A composition comprising:
a hydroxyetheramine polymer system comprising a polyhydroxyetheramine, a copolyhydroxyetheramine, a mixture of polyhydroxyaetheramine polymers, a mixture of copolyhydroxyetheramine polymers, or a mixture of polyhydroxyetheramine and copolyhydroxyetheramine represented by the formula: 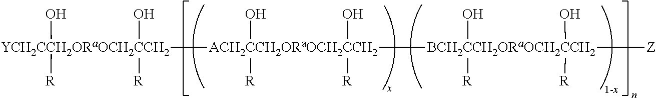
where:
R is independently selected from hydrogen and C₁-C₂₀ alkyl;
R^{a} is individually selected from an aromatic moiety and a substituted aromatic moiety;
Y is a hydrogen atom or an organic moiety that does not contain an epoxy group;
Z is a hydrogen atom or an organic moiety optionally containing an epoxy group;
n is 5-400;
x a real number having a value between 0.0 and 1.0;
A is individually selected from an amino group represented by one of the following formulas: 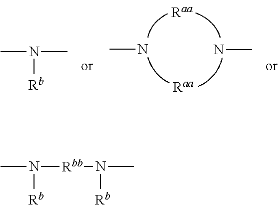
where:
R^{b} is independently selected from hydrocarbyl group and substituted hydrocarbyl group;
R^{aa} is independently selected from C₂-C₁₀ hydrocarbyleneyf group or substituted hydrocarbylene group;
R^{bb} is independently selected from C₂-C₂₀ hydrocarbylene and substituted hydrocarbylene; and the substituent(s) is independently selected from the group consisting of hydroxyl, cyano, halo, aryloxy, alkylamido, arylamido, alkycarbonyl, or arylcarbonyl; and
B is represented by the formula: 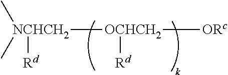
where:
R^{c} is hydrocarbyl group;
R^{d} is independently selected from the group consisting of hydrogen and hydrocarbyl group; and
k is an integer having a value between 1 and 1000, and
an effective amount of an anti-gelling system comprising quaternary ammonium compounds, quaternary phosphonium compounds, or mixtures and combinations thereof.

2. The composition of claim 1, wherein:
the tetra hydrocarbyl ammonium salts are represented by the formula:
R¹R²R³R⁴N⁺Q⁻
where R¹, R², R³, and R⁴ are the same or different hydrocarbyl groups having between 1 and 80 carbon atoms, where at least one of the hydrocarbyl groups has at least 8 carbon atoms and where Q⁻ is a halide ion, a CH₃SO₄⁻ group, a CH₃CH₂SO₄⁻ group, a hydroxide ion (OH⁻), an acetate ion (OAc⁻), or mixtures and combinations thereof, and/or
the tetra hydrocarbyl phosphonium salts are represented by the formula:
R¹R²R³R⁴P⁺Q⁻
where R¹, R², R³, and R⁴ are the same or different hydrocarbyl groups having between 1 and 80 carbon atoms, where at least one of the hydrocarbyl groups has at least 8 carbon atoms and where Q⁻ is a halide ion, a CH₃SO₄⁻ group, a CH₃CH₂SO₄⁻ group, a hydroxide ion (OH⁻), an acetate ion (OAc⁻), or mixtures and combinations thereof,
where one or more of the carbon atoms may be replaced by hetero atoms or hetero atom containing groups selected from the group consisting of: (1) a boron atom in the form of a borane group, (2) a nitrogen atom in the form of an amino group, (3) a nitrogen-containing group in the form of an amido group, an imino group, an imido group, an urea group, or mixtures thereof, (4) an oxygen atom in the form of an ether group, (5) an oxygen-containing group in the form of a carbonate group, an aldehyde group, a keto group or mixtures thereof, (6) a phosphorus atom in the form of a phosphine, (7) a phosphorus-containing group in the form of a phosphonate, phosphinate, or mixtures thereof, (8) a sulfur atom in the form of a sulfide group, (9) a sulfur-containing group in the form of a thio keto group, thio carbonate group, or mixtures thereof, and (10) mixtures or combinations thereof, and
where one or more of the hydrogen atoms may be replaced by hetero atoms or groups selected from the group consisting of: (1) halide atoms (F, Cl, Br, and/or I), (2) groups including hydroxy groups, alkoxy groups, amido groups, thiol groups, and mixtures thereof, and (3) mixtures or combinations thereof.

3. The composition of claim 2, wherein:
the tetrahydrocarbylammonium salts are trihydrocarbyl alkyl ammonium salts or mixtures of trihydrocarbyl alkyl ammonium salts represented by the following formula: 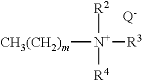
and
the tetrahydrocarbyl phosphonium salts are trihydrocarbyl alkyl phosphonium salts or mixtures of trihydrocarbyl alkyl phosphonium salts represented by the following formula: 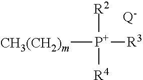
where m is an integer having a value between 6 and 40.

4. The composition of claim 3, wherein the trihydrocarbyl alkyl ammonium salts comprise trimethyl alkyl ammonium salts and the trihydrocarbyl alkyl phosphonium salts comprise trimethyl alkyl phosphonium salts.

5. The composition of claim 2, wherein:
the tetrahydrocarbyl ammonium salts are dihydrocarbyl dialkyl ammonium salts or mixtures of dihydrocarbyl dalkyl ammonium salts represented by the following formula: 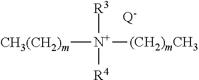
and
the tetrahydrocarbyl phosphonium salts are dihydrocarbyl dialkyl phosphonium salts or mixtures of dihydrocarbyl dialkyl phosphonium salts represented by the following formula: 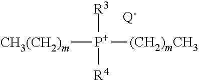
where each m is an integer having a value between 6 and 40.

6. The composition of claim 2, wherein the tetrahydrocarbyl ammonium salts comprise dimethyldihydrocarbylammonium salts given by the general formula R³R⁴Me₂N⁺Q⁻ and/or tetrahydrocarbylphosphonium salts comprise dimethyldihydrocarbylphosphonium salts given by the general formula R³R⁴Me₂P⁺Q⁻.

7. The composition of claim 6, wherein the tetrahydrocarbylphosphonium salt comprises tributylhexadecylphosphonium bromide and trihexyltetradecyl phosphonium chloride.

8. The composition of claim 7, wherein the dimethyldihydrocarbylammonium salts comprise C₁₂-C₁₆ alkyl dimethyl benzyl ammonium chlorides, C₁₂-C₁₆ alkyl dimethyl ethyl ammonium ethoxysulfates, di-(octadecyl-hexadecyl)dimethyl ammonium chlorides, didodecyldimethyl ammonium chloride, dodecyltrimethylammonium chloride, cocoalkyltrimethylammonium chloride and tallowalkyltrimethyl ammonium chloride, Aliquat HTA-1, and mixtures or combinations thereof.

9. The composition of claim 8, wherein the tetrahydrocarbylammonium salt is prepared by reacting C₁₂-C₁₆ alkyl dimethylamines with (i) benzyl chloride, (ii) diethyl sulfate, (iii) methyl sulfate, (iv) methyl chloride, (v) dichloroethylether, (vi) acetic acid, or (vii) mixtures of combinations thereof.

10. The composition of claim 6, wherein the dimethyldihydrocarbylammonium salts comprise di-(C₁₂-C₁₆ alkyldimethylamine) diethyl ether dichloride salts.

11. The composition of claim 10, wherein the di-(C₁₂-C₁₆ alkyldimethylamine)ethyl ether dichloride salts are prepared by reacting C₁₂-C₁₆ alkyl dimethylamine with dichloroethylether.

12. The composition of claim 2, wherein the tetrahydrocarbylammonium salts comprise trimethylhydrocarbylammonium salts given by the general formula R⁴Me₃N⁺Q⁻ and the tetrahydrocarbylphosphonium salts comprise trimethylhydrocarbylphosphonium salts given by the general formula R⁴Me₃P⁺Q⁻.

13. The composition of claim 2, wherein:
the tetrahydrocarbylammonium salts comprise amidotrihydrocarbyl ammonium salts represented by the general formula: 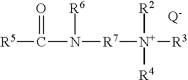
and
the tetrahydrocarbylphosphonium salts comprise amidotrihydrocarbyl phosphonium salts represented by the general formula: 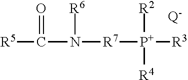
where R⁵ is a hydrocarbyl group having between 1 and 80 carbon atoms, R⁶ is a hydrogen atom or a hydrocarbyl group having between 1 and 80 carbon atoms, and R⁷ is a linking group having between 1 and 10 carbon atoms.

14. The composition of claim 13, wherein the carbylamidoalkyltrihydrocarbyl ammonium salts comprise oleylamidopropyltrimethyl ammonium chloride, laurylamidopropyltrimethyl ammonium chloride, cocoamidopropyltrimethyl ammonium chloride, cocoamidopropyltrimethyl ammonium chloride, cocoamidopropyldimethyl benzyl ammonium bromide, cocoamidopropyldimethylethyl ammonium ethoxysulfate, cocoamidopropyltrimethyl ammonium methoxysulfate, and mixtures or combinations thereof.

15. The composition of claim 2, wherein:
the quaternary ammonium compounds comprise diammonium salts represented by the formula: 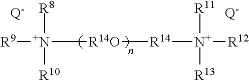
and
the quaternary phosphonium compounds comprise diphosphonium salts represented by the formula: 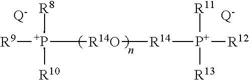
where R⁸, R⁹, R¹⁰, R¹¹, R¹², and R¹³ are independently hydrocarbyl group having between 1 and 80 carbon atoms, R¹⁴ is a linking group having between 1 and 4 carbon atoms, and n is an integer having a value of from 1 to 4.

16. The composition of claim 15, wherein the diammonium salts are given by following formula: 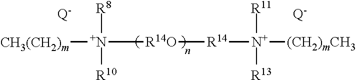
and
the quaternary phosphonium compounds comprise diphosphonium salts represented by the formula: 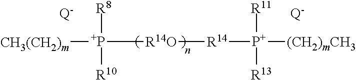
where R⁸, R¹⁰, R¹¹, and R¹³ are alkyl from 1 to 12 carbons and each m is independently an integer having a value between 6 and 40.

17. The composition of claim 16, wherein the diammonium salt comprises di(C₁₂-C₁₄-alkyl)dimethylamine)diethylether dichloride.

18. The composition in claim 1, wherein the effective amount of the anti-gelling system is between about 0.03 wt. % and to 20.00 wt. % based on the weight of hydroxyetheramine polymer system.

19. The composition of claim 1, wherein the effective amount of the anti-gelling system is between about 0.05 wt. % and about 10.00 wt. % based on the weight of hydroxyetheramine polymer system.

20. The composition of claim 1, wherein the effective amount of the anti-gelling system is between about 0.1 wt. % and about 10.00 wt. % based on the weight of hydroxyetheramine polymer system.

21. The composition of claim 1, wherein the effective amount of the anti-gelling system is between about 0.1 wt. % and 5 wt. % based on the weight of hydroxyetheramine polymer system.

22. The composition of claim 1, wherein a viscosity of the composition remains under 230 cps in the temperature range between 100° F. (37.8° C.) and 400° F. (204.4° F.).

23. The composition of claim 1, wherein:
R is hydrogen;
R^{a} is independently selected from the group consisting of isopropylidenediphenylene, 1,4-phenylene, 1,3-phenylene, methylenediphenylene, thiodiphenylene, and carbonydiphenylene;
R^{b} is independently selected from the group consisting of methyl, ethyl, phenyl, benzyl, 2-hydroxyethyl, 3-hydroxypropyl, 2-hydroxypropyl, 2,3-dihydroxypropyl, 2-(acetamido)ethyl; and
R^{aa} and R^{bb} are independently selected from the group consisting of ethylene, 1,2-propylene, and 1,2-butylene.

24. The composition of claim 1, wherein:
R^{a} is isopropylidenediphenylene;
R^{b} is 2-hydroxyethyl;
Y is N-(2-hydroxyethyl)piperazinyl or bis(2-hydroxyethyl)amino;
Z is N-(2-hydroxyethyl)piperazinyl or bis(2-hydroxyethyl)amino, and
n is 10-25.

25. The composition of claim 1, further comprising:
an aqueous based fluid to form aqueous fluids.

26. The composition of claim 1, further comprising:
an oil based fluid to form oil-based fluids.

27. A method of reducing the water permeability of a wellbore during the drilling comprising the step:
circulating a fluid in the wellbore, where the fluid includes an effective amount of a permeation modifier composition comprising:
a hydroxyetheramine polymer system comprising a polyhydroxyetheramine, a copolyhydroxyetheramine, a mixture of polyhydroxyetheramine polymers, a mixture of copolyhydroxyetheramine polymers, or a mixture of polyhydroxyetheramine and copolyhydroxyetheramine represented by the formula: 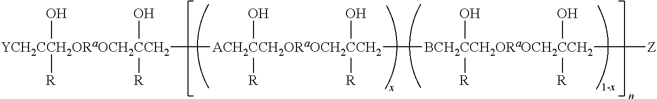
where:
R is independently selected from hydrogen and C₁-C₂₀ alkyl;
R^{a} is individually selected from an aromatic moiety and a substituted aromatic moiety;
Y is a hydrogen atom or an organic moiety that does not contain an epoxy group;
Z is a hydrogen atom or an organic moiety optionally containing an epoxy group;
n is 5-400;
x a real number having a value between 0.0 and 1.0;
A is individually selected from an amino group represented by one of the following formulas: 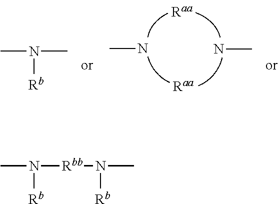
where:
R^{b} is independently selected from hydrocarbyl group and substituted hydrocarbyl group;
R^{aa} is independently selected from C₂-C₁₀ hydrocarbylene group or substituted hydrocarbylene group;
R^{bb} is independently selected from C₂-C₂₀ hydrocarbylene and substituted hydrocarbylene; and the substituent(s) is independently selected from the group consisting of hydroxyl, cyano, halo, aryloxy, alkylamido, arylamido, alkycarbonyl, or arylcarbonyl; and
B is represented by the formula: 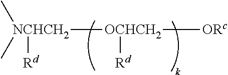
where:
R^{c} is hydrocarbyl group;
R^{d} is independently selected from the group consisting of hydrogen and hydrocarbyl group; and
k is an integer having a value between 1 and 1000, and
an effective amount of an anti-gelling system comprising quaternary ammonium compounds, quaternary phosphonium compounds, or mixtures and combinations thereof,
where the permeation modifier composition reduces a water permeability of the wellbore.

28. The method of claim 27, wherein the fluid comprises a drilling fluid.

29. The method of claim 28, wherein the drilling fluid comprises a water base drilling fluid.

30. The method of claim 28, wherein the drilling fluid comprises an oil-based drilling fluid.

31. The method of claim 27, wherein the fluid comprises part of a pill.

32. The method of claim 31, wherein the pill comprises an aqueous carrier liquid.

33. The method of claim 27, where the fluid is an aqueous carrier liquid.

34. The method of claim 33, wherein the aqueous carrier liquid is an aqueous salt solution.

35. The method of claim 34, wherein the aqueous salt solution is selected from the group consisting of potassium chloride, sodium chloride, sodium bromide, sodium acetate, ammonium chloride, and calcium chloride and is present in the aqueous salt solution in an amount in the range between about 1% and about 10% by weight of solution.

36. The method of claim 27, where in the fluid reduces a water permeability of limestone in the wellbore, a water permeability of sandstone in the wellbore, a water permeability of a proppant pack, or mixtures and combinations thereof.
